(19) United States
(12) Patent Application Publication
(10) Pub. No.: US 2017/0041817 A1
(43) Pub. Date: Feb. 9, 2017

(54) COMMUNICATION MANAGEMENT APPARATUS, WIRELESS TERMINAL, AND NON-TRANSITORY MACHINE-READABLE STORAGE MEDIUM

(71) Applicant: HITACHI, LTD., Tokyo (JP)

(72) Inventors: Yusuke SHOMURA, Tokyo (JP); Rintaro KATAYAMA, Tokyo (JP); Ryoichi TANAKA, Tokyo (JP); Tomohiro MATSUDA, Tokyo (JP)

(73) Assignee: HITACHI, LTD., Tokyo (JP)

(21) Appl. No.: 15/229,796

(22) Filed: Aug. 5, 2016

(30) Foreign Application Priority Data
Aug. 6, 2015 (JP) 2015-155667

(51) Int. Cl. H04W 24/08; H04L 12/26; H04L 12/851; H04L 12/801

(52) U.S. Cl. CPC H04W 24/08; H04L 47/11; H04L 43/045; H04L 47/24

(57) ABSTRACT

To estimate communication quality of the wireless section in real-time, it is provided a communication management apparatus that manages traffic of a communication system, comprising a storage unit which stores a program, and a processor which executes the program stored in the storage unit, wherein the communication system includes a wireless base station that communicates with a wireless terminal, and a gateway apparatus connected to the wireless base station, and wherein the communication management apparatus is configured to: obtain a degree of congestion of the wireless base station; obtain a wireless quality of the wireless terminal, between the wireless base station and the wireless terminal; and calculate an estimated communication quality value of the wireless terminal between the gateway apparatus and the wireless terminal, according to the degree of congestion of the wireless base station and the obtained wireless quality of the wireless terminal.

### CLAIM OF PRIORITY

The present application claims priority from Japanese patent application JP 2015-155667 filed on Aug. 6, 2015, the content of which is hereby incorporated by reference into this application.

### BACKGROUND

The present invention relates to a communication management apparatus that manages the traffic of a wireless communication system.

A wireless communication system such as a cellular communication system is provided with a communication management server (TMS server), and monitors and controls traffic in the system. The communication management server gathers data regarding the degree of congestion in a base station.

Terminals in a cellular wireless communication system handle not only voice calls but applications as well (such as web browsers and video players), and transmit and receive data. In order for applications to operate smoothly, there is a need to ensure communication quality suited to applications.

JP 2011-155600 A is an example of background art of the present technique. JP 2011-155600 A discloses a communication control apparatus including a terminal communication optimization function unit and a network-side communication optimization function unit, wherein the terminal communication optimization function unit includes: a function unit that obtains first information indicating an application running on a terminal and a communication destination of the application; a function unit that forwards the first information; and a function unit that sets the communication quality of each application according to second information that is command information, and wherein the network-side communication optimization function unit includes: a function unit that obtains third information indicating the communication quality necessary for each application indicated by the first information, and fourth information relating to a state of a network; a function unit that determines the presence or lack of network resources necessary for each application according to the first information; and a function unit that, in the case where the network resources are insufficient, causes applications with a high priority for communication to engage in communication at a first communication quality, and causes applications with a low communication priority to engage in communication at a range that does not result in deterioration of the first communication quality (see abstract).

### SUMMARY

Generally, in wireless communication systems, even in the case where the terminal is connected to a base station and voice calls are possible, it is unknown whether the communication quality is high enough to allow applications to run. Also, the necessary communication quality differs depending on the application. In other words, it is difficult to represent the operation quality of applications by the SINR (signal-to-interference and noise power ratio) used to control an LTE system, and even if a downstream pilot signal could be received, for example, a web browser might not be able to load a website.

Thus, communication quality (throughput, delay, etc.), which is an important index for data transmission used by applications, needs to be estimated, and it also needs to be correctly estimated whether communication quality to a degree that applications can be used is ensured.

The representative one of inventions disclosed in this application is outlined as follows. There is provided a communication management apparatus that manages traffic of a communication system, comprising a storage unit which stores a program and a processor which executes the program stored in the storage unit. The communication system includes a wireless base station that communicates with a wireless terminal, and a gateway apparatus connected to the wireless base station. The communication management apparatus obtains a degree of congestion of the wireless base station, obtains a wireless quality of the wireless terminal, between the wireless base station and the wireless terminal, and calculates an estimated communication quality value of the wireless terminal between the gateway apparatus and the wireless terminal, according to the degree of congestion of the wireless base station and the obtained wireless quality of the wireless terminal.

A representative aspect of the present invention can estimate the communication quality of a terminal. Objects, configurations, and effects other than those described above become apparent from the following description of one embodiment of the present invention.

### BRIEF DESCRIPTION OF THE DRAWINGS

The present invention can be appreciated by the description which follows in conjunction with the following figures, wherein:

FIG. 1 is a diagram illustrating a configuration of a wireless communication system according to a first embodiment;

FIG. 2 is a diagram illustrating a configuration of a traffic management server according to the first embodiment;

FIG. 3 is a diagram illustrating an example of an application coverage map of the first embodiment;

FIGS. 4A and 4B are diagrams illustrating configuration examples of a base station congestion information management table of the first embodiment;

FIG. 5 is a diagram illustrating a configuration example of a application-required quality management table of the first embodiment;

FIG. 6 is a diagram illustrating a configuration example of a base station setting information management table of the first embodiment;

FIG. 7 is a flow chart of an application coverage plotting process of the first embodiment;

FIG. 8 is a flow chart of a communication quality estimation process of the first embodiment;

FIG. 9 is a flow chart of an application availability level calculation process of the first embodiment;

FIG. 10 is a diagram illustrating a configuration of a wireless communication system according to a second embodiment;

FIG. 11 is a diagram illustrating a configuration example of an application server of the second embodiment;

FIG. 12 is a diagram illustrating a configuration example of a terminal log management table of the second embodiment;

FIG. 13 is a diagram illustrating a configuration example of an estimation formula parameter management table of the second embodiment;

FIGS. 14A and 14B are diagrams illustrating configuration examples of a wireless quality map information management table of the second embodiment;

FIG. 15A is a diagram illustrating an example of a wireless quality map of the second embodiment;

FIG. 15B is a diagram illustrating an example of an application coverage map of the second embodiment;

FIG. 16 is a flow chart of an estimation formula parameter generation process of the second embodiment;

FIG. 17 is a flow chart of a wireless quality map creation process of the second embodiment;

FIG. 18 is a diagram illustrating a configuration of a traffic management server according to the second embodiment;

FIG. 19 is a flow chart of a communication quality estimation process of the second embodiment;

FIG. 20 is a diagram illustrating another example of a wireless quality map of the second embodiment;

FIG. 21 is a sequence diagram of a message exchange between a UE and a traffic management server according to a third embodiment;

FIGS. 22A to 22D are diagrams illustrating formats of messages transmitted and received between the UE and the traffic management server according to the third embodiment;

FIG. 23 is a diagram illustrating a configuration of the UE according to the third embodiment;

FIG. 24 is a diagram illustrating a configuration example of an application-based communication control management table according to the third embodiment; and

FIG. 25 is a flow chart of an application-based communication control process according to the third embodiment.

### DETAILED DESCRIPTIONS OF EMBODIMENTS

Embodiments of the present invention will be described in detail below with reference to drawings.

In the embodiments below, descriptions will be divided into multiple sections or embodiments as necessary for ease of explanation, but unless otherwise noted, the divided sections or embodiments are not unrelated to each other, and one section or embodiment is a modification example, a detail, or an addition, in part or in entirety, to another section or embodiment.

Also, in the embodiments below, in the case of referring to the number of elements or the like (including number, value, amount, range, etc.), unless otherwise noted or if the number is clearly limited to a specific value due to theoretical reasons, the number of elements is not limited to that specific value and may be more or less than the value.

Furthermore, in the embodiments below, it is obvious that the components thereof (including element steps) are not strictly necessary unless otherwise noted, or if such components are clearly understood to be necessary for theoretical reasons.

The present embodiment is of a cellular communication system that employs LTE, which is standardized according to 3GPP, as an example of a wireless communication system.

### First Embodiment

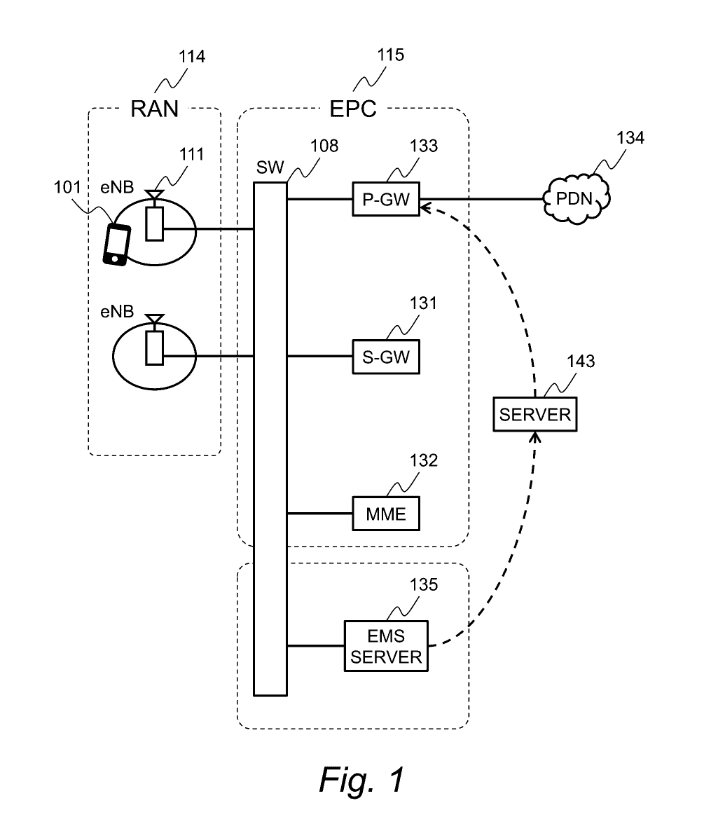

FIG. 1 is a diagram illustrating a configuration of a wireless communication system according to a first embodiment.

The wireless communication system of the first embodiment has an eNodeB 111 that is a base station, an S-GW 131 and a P-GW 133 that are gateway apparatuses, an MME 132 that is a communication control apparatus, an EMS server 135, and a traffic management server 143. The eNodeB 111 is connected to a UE 101, which is a user terminal.

The S-GW 131 has a traffic forwarding function for a user plane. The P-GW 133 has an interface with a PDN 134, which is a packet data network that provides a service to users. The MME 132 is a apparatus that manages the mobility of the UE 101, and transmits and receives control plane signaling. The S-GW 131, the P-GW 133, and the MME 132 are connected to each other and constitute a core network 115 (EPC).

The EMS server 135 is an element management system that manages nodes included in the wireless communication system. Specifically, the EMS server 135 gathers statistical information for each node (number of UEs 101 connected to the eNodeB 111, CQI (Channel Quality Indicator) distribution, usage rate of physical resource blocks (PRB), etc.).

The traffic management server 143 uses information obtained from the EMS server 135 to estimate communication quality. Communication quality refers to the communication quality for each user terminal, and in this case, is an index indicating the downstream reception quality of the mobile network, that is the downstream reception quality between the P-GW and the user terminal. However, since a sufficiently large bandwidth can generally be ensured for the wired portion of the mobile network, it is assumed that communication quality is restricted in definition to that of the wireless portion, which is a bottleneck. The traffic management server 143 may transmit an estimated communication quality value to the P-GW 133. The P-GW 133 can use the estimated communication quality value transmitted from the traffic management server 143 in order to control communication by applications (such as reducing the data rate of a video in the case of bad communication quality).

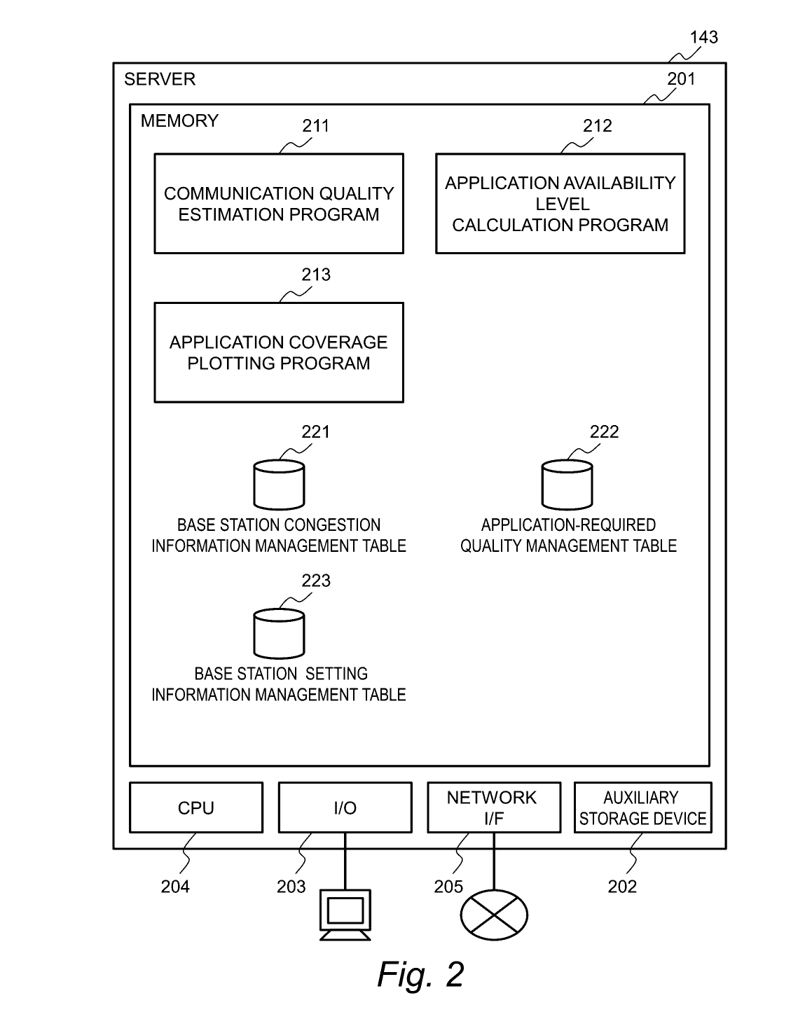

FIG. 2 is a diagram illustrating a configuration of a traffic management server 143 according to the first embodiment.

The traffic management server 143 is constituted of a general computer, and has a processor 204 (CPU), a memory 201, an auxiliary storage apparatus 202, an input/output interface 203, and a network interface 205.

The input/output interface 203 is a user interface used in order for the user to input commands to the traffic management server 143, and for displaying results of execution of a program to the user. An input/output device (such as a keyboard, mouse, touch panel, display, or printer) is connected to the input/output interface 203. A user interface provided by the terminal connected through the network may be connected to the input/output interface 203.

The CPU 204 is a processor that executes programs stored in the memory 201. The memory 201 includes ROM, which is a non-volatile memory element, and RAM, which is a volatile memory element. The ROM includes fixed programs (such as the BIOS). The RAM is a high speed and volatile memory element such as DRAM (dynamic random access memory), and temporarily stores programs stored in the auxiliary storage device 202 and data used during execution of the programs.

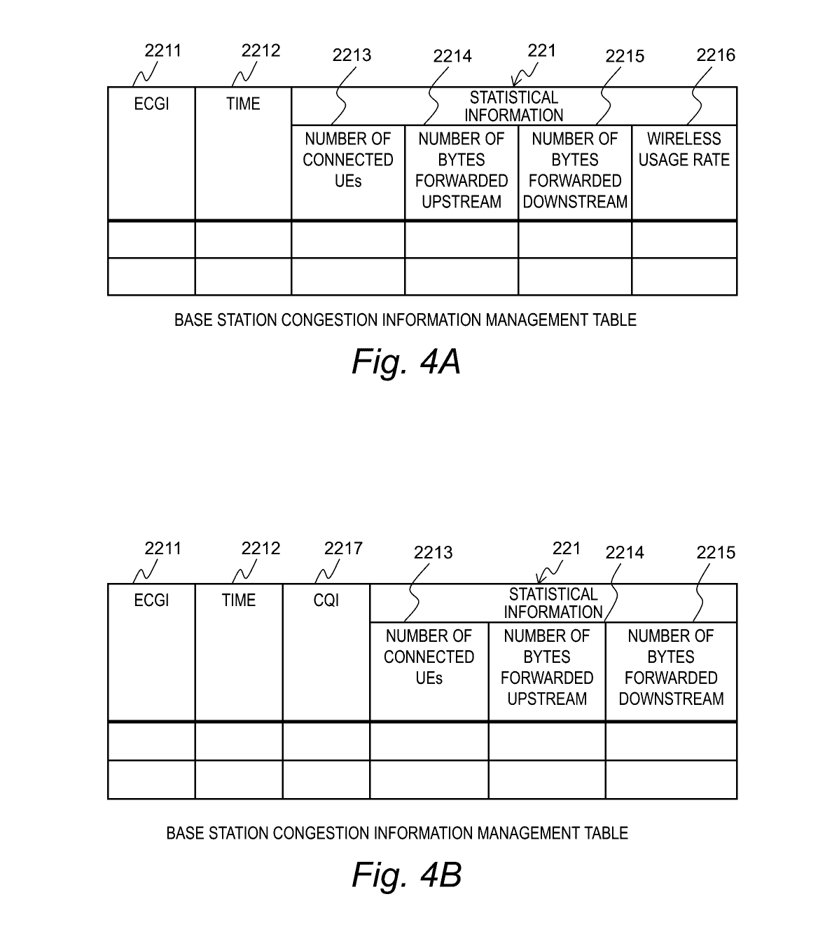

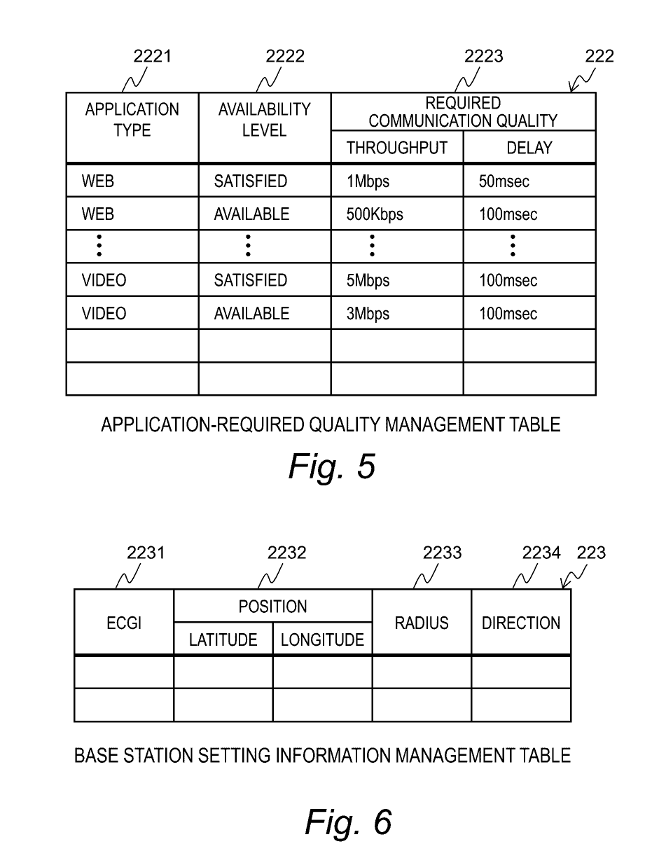

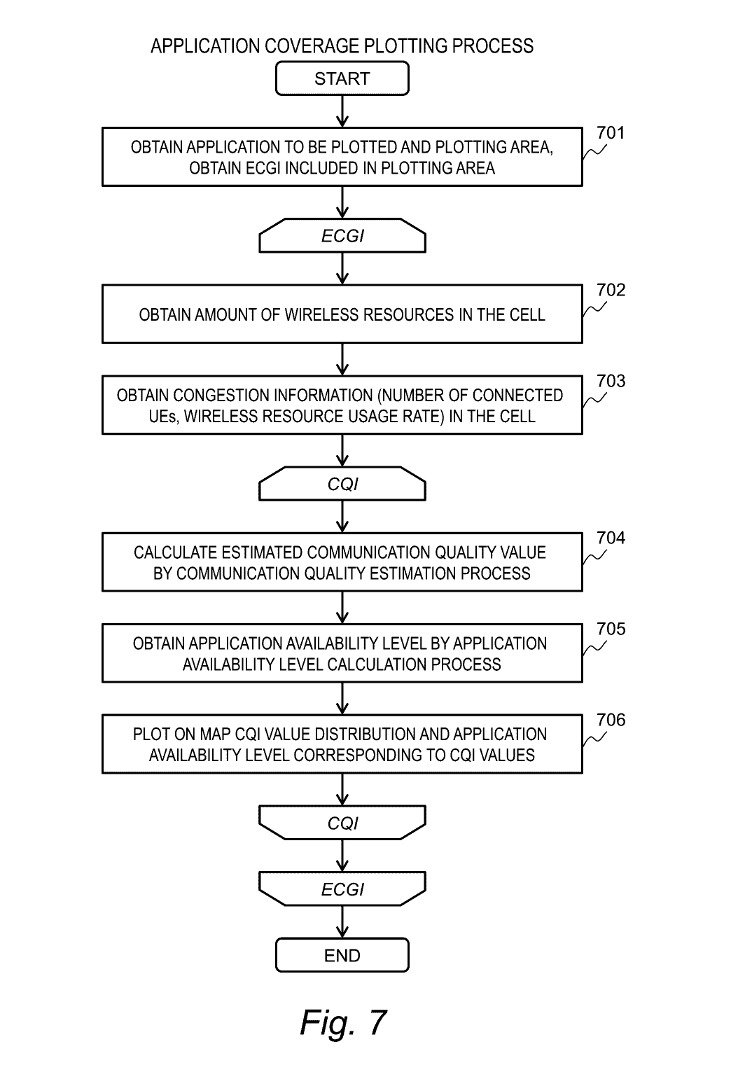

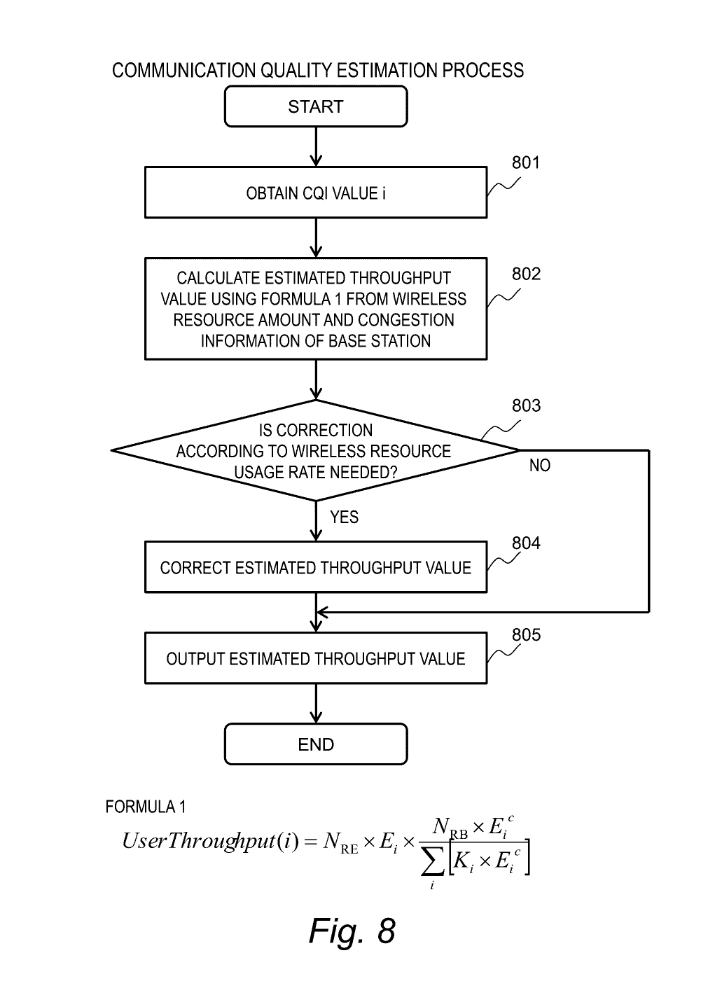

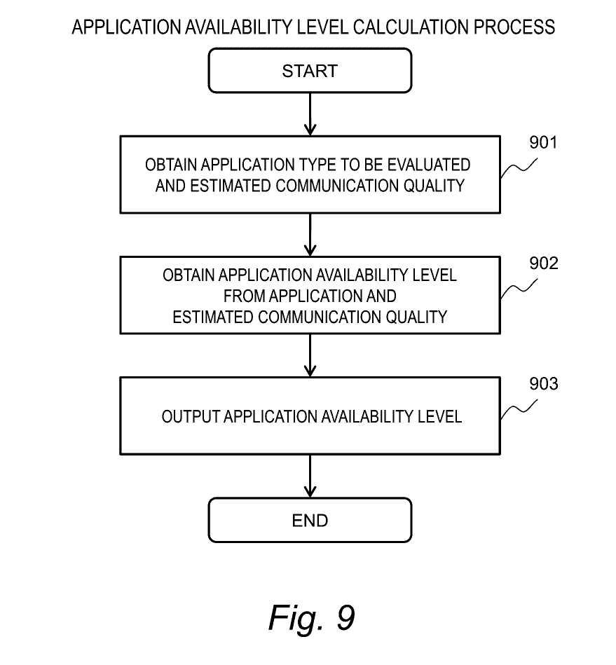

Specifically, the memory 201 stores a communication quality estimation program 211, an application availability level calculation program 212, and an application coverage plotting program 213. The communication quality estimation program 211 executes a communication quality estimation process (see FIG. 8). The application availability level calculation program 212 executes an application availability level calculation process (see FIG. 9). The application coverage plotting program 213 executes an application coverage plotting process (see FIG. 7). Also, the memory 201 stores a base station congestion information management table 221 (see FIGS. 4A and 4B), an application-required quality management table 222 (see FIG. 5), and a base station setting information management table 223 (see FIG. 6).

The auxiliary storage device 202 is a high capacity and non-volatile storage device such as a magnetic storage device (HDD) or flash memory (SSD), for example. Also, the auxiliary storage device 202 stores programs to be executed by the CPU 204 and data to be used while executing the programs. In other words, the programs are read from the auxiliary storage device 202, loaded into the memory 201, and executed by the CPU 204.

The network interface 205 is an interface device that controls communications with other apparatuses (such as the P-GW 133 and the EMS server 135) through the network.

Programs executed by the CPU 204 are provided to the traffic management server 143 through removable media (such as CD-ROMs and flash memory) or through a network, and are stored in a non-volatile storage device, which is a non-transitory storage medium. Thus, the traffic management server 143 would have an interface for reading in data from removable media.

The traffic management server 143 is a computer system constituted of one physical computer or a plurality of logical or physical computers, and the aforementioned programs may operate in individual threads on the same computer, or in a virtual computer created within a plurality of physical computer resources. Also, the traffic management server 143 and any other apparatus may be stored in one physical or logical computer.

Some or all of the functions of the function unit realized by the programs may alternatively be realized by hardware (such as a field-programmable gate array).

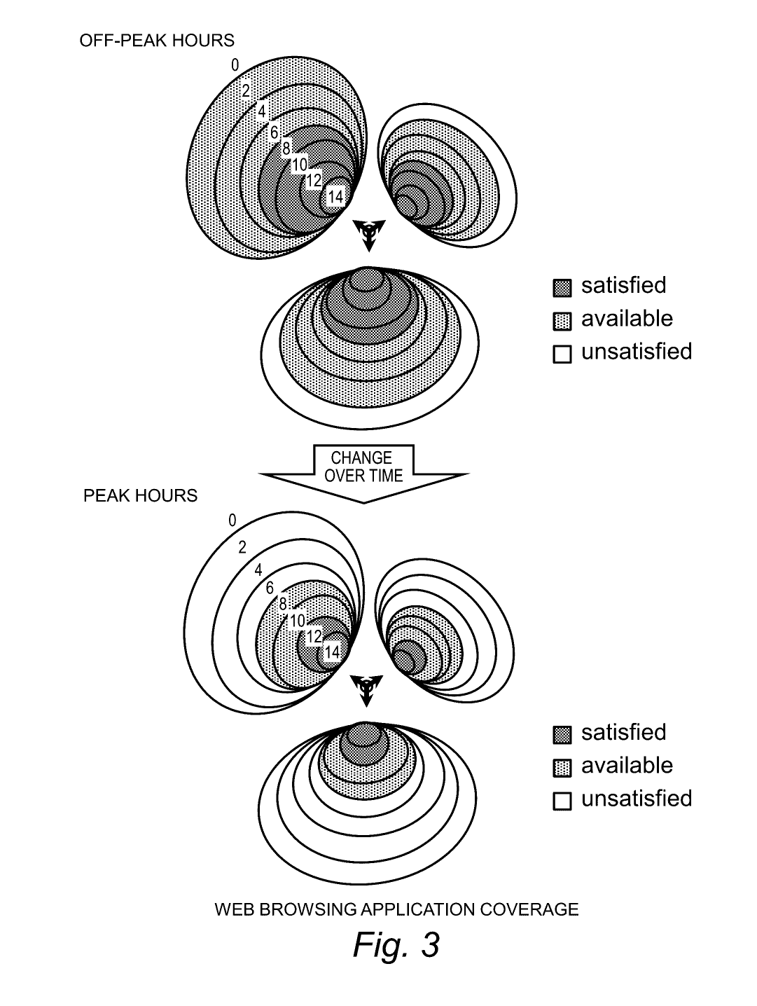

FIG. 3 is a diagram illustrating an example of an application coverage map of the first embodiment.

The application coverage map illustrated in FIG. 3 indicates the communication quality when a website is being viewed using a web browser, for example. In the map, the communication quality corresponding to each channel quality indicator (CQI) is ranked into the following three availability levels: “satisfied”, indicating full quality being provided; “available”, indicating that a quality sufficient for use is being provided; and “unsatisfied”, indicating that satisfactory quality cannot be provided. The availability levels are defined in the application-required quality management table 222, and indicate the user experience of the application, that is, whether the communication quality is suited to use of the application. In the present embodiment, the three availability levels (satisfied, available, and unsatisfied) are defined, but there may be any number of availability levels. Alternatively, a value mapped to a mean opinion score (MOS) during use of the application may be used as the communication quality.

The CQI is an index indicating reception quality of the downstream channel between the base station and the user terminal, and this value is defined in advance by the communication system. There are 16 levels of CQI values defined from 0 to 15, for example, and a modulation scheme and transmission rate are defined in correspondence with each CQI value. In the present embodiment, the CQI distribution in cells is assumed to be known in advance. By gathering the position and CQI of the UE 101 in the cell, for example, it is possible to create a CQI distribution in the cell. As long as the cell environment does not change, the CQI distribution does not greatly change, and thus, the CQI distribution only needs to be measured every prescribed period (1 day to 1 month).

Of the 16 levels defined for the CQI, for example, during off-peak times, a CQI of 8-15 is defined as “satisfied”, a CQI of 2-7 is defined as “available”, and a CQI of 0-1 is defined as “unsatisfied”.

The communication quality corresponding to the CQI changes over time. In other words, during peak usage times, the amount of physical resource blocks distributed to the UE 101 is small, and thus, the communication quality decreases even at the same CQI level. As illustrated in FIG. 3, for example, during peak times, a CQI of 12-15 is defined as “satisfied”, a CQI of 8-11 is defined as “available”, and a CQI of 0-7 is defined as “unsatisfied”.

Also, an estimated communication quality value may be displayed instead of the application availability level. Alternatively, the estimated communication quality value may be displayed in addition to the application availability level.

In the first embodiment, the application coverage map illustrated in FIG. 3 is displayed, and thus, the boundaries of the CQIs, that is, the boundaries of the availability levels of the applications are displayed on a map in a substantially concentric manner by arcs formed by connecting points of equal distance from the eNodeB antenna.

In this manner, by displaying the relation between the CQI and communication quality using an application coverage map, it is possible to represent the relationship between the application availability quality and the position.

FIGS. 4A and 4B are diagrams illustrating configuration examples of the base station congestion information management table 221 of the first embodiment.

The base station congestion information management table 221 stores congestion information of the base station 111 (eNodeB). Specifically, the base station congestion information management table 221 illustrated in FIG. 4A includes an E-UTRAN cell global ID 2211 (ECGI) for uniquely identifying a cell of the eNodeB 111, a time 2212 at which the congestion information was obtained, a number 2213 of UEs 101 connected to the cell, an upstream data amount 2214 (in bytes) forwarded by the cell, a downstream data amount 2215 (in bytes) forwarded by the cell, and a physical wireless resource usage rate 2216.

The base station congestion information management table 221 illustrated in FIG. 4B differs from the base station congestion information management table 221 illustrated in FIG. 4A in that congestion information is recorded for each CQI. The CQI distribution in the cell changes over time, and thus, by recording congestion information per CQI, it is possible to find an accurate CQI distribution.

Specifically, the base station congestion information management table 221 includes an ECGI 2211 for uniquely identifying a cell of the eNodeB 111, a time 2212 at which the congestion information was obtained, a CQI 2217, a number 2213 of UEs 101 connected to the cell, an upstream data amount 2214 (in bytes) forwarded by the cell, and a downstream data amount 2215 (in bytes) forwarded by the cell. The base station congestion information management table 221 may include a physical wireless resource usage rate 2216. In such a case, the physical wireless resource usage rate 2216 is recorded for each ECGI and not each CQI.

FIG. 5 is a diagram illustrating a configuration example of the application-required quality management table 222 of the first embodiment.

The application-required quality management table 222 stores the quality required according to application type. Specifically, the application-required quality management table 222 includes an application type 2221, an availability level 2222, and a required communication quality 2223. The availability level 2222 indicates the user experience of the application, that is, to what degree the application is usable. The required communication quality 2223 includes throughput and delay, but may include other indices indicating communication quality (such as packet loss rate, and jitter).

FIG. 6 is a diagram illustrating a configuration example of the base station setting information management table 223 of the first embodiment.

The base station setting information management table 223 stores position information of cells provided by the eNodeB 111. Specifically, the base station setting information management table 223 includes an ECGI 2211 for uniquely identifying a cell of the eNodeB 111, a position 2232 (latitude, longitude) where the eNodeB 111 is located, a cell radius 2233 that is the distance between the boundary of the cell provided by the eNodeB 111 and the eNodeB 111, and a direction 2234 where the cell provided by the eNodeB 111 is formed (angle from a reference orientation).

FIG. 7 is a flow chart of an application coverage plotting process of the first embodiment. The application coverage plotting process is executed by the application coverage plotting program 213.

First the application coverage plotting program 213 (CPU 204) obtains an application to be plotted and a plotting area (701). The application type to be plotted can be obtained from information that is input by a user in an input/output device connected to the input/output interface 203. Application information used by the UE 101 may be obtained from a monitoring device (such as a DPI) provided in the wireless communication system, and the application type to be plotted may be determined from the obtained application information. The plotting area can be obtained from the latitude and longitude inputted by a user in an input/output device connected to the input/output interface 203, or from a region designated on a map.

Additionally, the application coverage plotting program 213 obtains, from the base station setting information management table 223, the ECGI of the eNodeB 111 where the provided cell is included in the plotting area (701).

Then, the application coverage plotting program 213 repeatedly executes the processes of steps 702 to 706 for each obtained ECGI.

During the loop, the amount of wireless resources that can be allocated to the UE 101 in the cell is obtained (702), and statistical information (number of connected UEs) representing the degree of congestion in the cell is obtained from the base station congestion information management table 221 (703). In the present embodiment, the number of connected UEs is used to represent the degree of congestion, but the wireless resource usage rate, data forwarding amount, or the number of handovers (increase or decrease in the number of UEs 101 in the cell) may be used instead.

Then, the application coverage plotting program 213 repeatedly executes the processes of steps 704 to 706 for each obtained CQI. As described above, the CQI value ranges are determined in advance by the system.

In step 704, the communication quality estimation program 211 is started, and the communication quality estimation program 211 executes a communication quality estimation process (FIG. 8) and calculates an estimated throughput value. Then, in step 705, the application availability level calculation program 212 is started, and the application availability level calculation program 212 executes an application availability level calculation process (FIG. 9) and obtains the application availability level.

Then, the application coverage plotting program 213 plots the CQI value distribution, and the application availability level corresponding to the CQI values, on a map (706). As described previously, the estimated communication quality value may be displayed instead of the application availability level. Alternatively, the estimated communication quality value may be displayed in addition to the application availability level. The application availability level calculation program 212 may store in a cache the results of executing the communication quality estimation process and the application availability level calculation process, and use the information from the cache when performing again the process pertaining to the ECGI at that time (or the degree of congestion), and omit the calculation process.

FIG. 8 is a flow chart of a communication quality estimation process of the first embodiment. The communication quality estimation process is executed by the communication quality estimation program 211.

First, the communication quality estimation program 211 (CPU 204) obtains an index i of the CQI value in the cell provided by the eNodeB 111 (801). As described above, the CQI value ranges are determined in advance by the system.

Then, the communication quality estimation program 211 calculates the estimated throughput value for each CQI using formula 1 according to the wireless resource amount and congestion information of the eNodeB 111 (802).

$$UserThroughput ( i ) = {N}_{RE} \times {E}_{i} \times \frac{{N}_{RB} \times {E}_{i}^{c}}{{\sum }_{i} [ {K}_{i} \times {E}_{i}^{c} ]} \qquad Formula 1$$

i: CQI Index

Ei: Efficiency at CQI Index i

N_{RB}: Number of Resource Blocks (System Bandwidth)

N_{RE}: Number of Resource Elements (Number of PDSCH REs per RB)

c: Coefficient for Proportional Fair Scheduling (c=0 for Round Robin)

Ki: Number of Users for CQI Index i

In formula 1, i is an index for the CQI value, and Ei is the transmission efficiency for when the CQI index is i (that is, the bitrate transmittable by one resource block). Also, c is a coefficient determined by a scheduler, and in the case of round robin, c=0 and Ei^{c}=1. The value c would be set to a value greater than 0 in the case of emphasizing the CQI, and would be set to less than 0 in the case of emphasizing fairness among UEs 101. Ki is the number of users where the CQI index is i, and represents the degree of congestion in the eNodeB 111. N_{RB} indicates the capability of the wireless base station, and is the number of resource blocks, which are the minimum unit of wireless resources allocated, and represents the system bandwidth. N_{RE} is the number of resource elements, which are the minimum unit of wireless resources, and specifically is the number of resources for the physical downlink shared channel (PDSCH) in each resource block.

In formula 1, Σ[Ki×Ei^{C}] may be replaced by a probability distribution of Ki×Ei^{C}. In such a case, the probability distribution of the throughput estimated value is calculated.

Then, the communication quality estimation program 211 determines whether to correct the estimated throughput value using the wireless resource usage rate (803). In the case where it is determined that the estimated throughput value should be corrected, then the system bandwidth NRB is corrected using formula 2, and the estimated throughput value is calculated using formula 1 with the corrected system bandwidth NRB (804).

N_{RB}=(1−usage rate)×N_{RB} Formula 2

Formula 1 is an equation for estimating the throughput in the case where the transmission buffers of the eNodeB 111 are always full (no vacant), and in the case where there is a vacant area in the transmission buffer, then a higher throughput can be attained. Thus, by correcting the estimated throughput value using formula 2, it is possible to estimate a more accurate throughput. Therefore, an option to correct the estimated throughput value would be provided.

Then, the communication quality estimation program 211 outputs the estimated throughput value calculated for each CQI, and stores it in the memory 201 (805).

In the present embodiment, the throughput was estimated using formula 1, but an approximation using a polynomial as in a second embodiment may be employed, or the communication quality may be estimated using a table in which the degree of congestion and communication quality are placed in association with each other.

FIG. 9 is a flow chart of an application availability level calculation process of the first embodiment. The application availability level calculation process is executed by the application availability level calculation program 212.

First, the application availability level calculation program 212 (CPU 204) obtains the type of application to be evaluated, and the communication quality (estimated throughput value for each CQI) estimated by the communication quality estimation program 211 (901). In the case where application information used by the UE 101 is to be obtained from a monitoring device (such as a DPI, which is not illustrated) provided in the wireless communication system, then the P-GW 133 may control communication according to the applications. Also, as described in a modification example of a third embodiment, the communication quality may be issued as a notification to the UE 101 to notify the user of the estimated communication quality value or the availability level of the application, and the operation of the application may be controlled.

The application availability level calculation program 212 refers to the application-required quality management table 222 to obtain the application availability level corresponding to the application and the estimated communication quality (902). For example, when using SQL, the application availability level can be obtained by the following SELECT text.

SELECT MAX (application availability level)

FROM application-required quality management table

WHERE

application type=application type to be evaluated AND throughput estimated throughput value AND delay estimated delay value

Then, the application availability level calculation program 212 outputs the obtained application availability level and stores it in the memory 201 (903).

As described above, in the first embodiment of the present invention, the traffic management server 143 calculates estimated values for the communication quality (throughput, delay, etc.) of the UE 101 according to the degree of congestion (number of connected UEs) in the eNodeB 111 and the wireless quality (CQI) of the UE 101, and thus, the communication quality of the UE 101 can be accurately estimated.

Also, the traffic management server 143 estimates the communication quality using a formula including as variables the capability of the eNodeB 111, the wireless quality (CQI) distribution of UEs 101 in the cell provided by the eNodeB 111, and a value determined according to the type of scheduler for allocating the wireless resources in the eNodeB 111, and thus, it is possible to accurately estimate the communication quality of the UE 101 using only information that can be obtained from the EMS server 135.

Also, the traffic management server 143 outputs data for displaying the communication quality estimation results on a map on which the position of the UE 101 in the cell and the wireless quality (CQI) are displayed in association with each other, and thus, it is possible to know the communication quality that can be obtained according to the location within the cell.

The traffic management server 143 stores the request value for the communication quality necessary for the application used by the UE 101 and stores it in the application-required quality management table 222, compares the estimated communication quality value that has been calculated and the stored communication quality requirement value, evaluates the degree to which the application availability rate is compatible with the estimation value in multiple stages, and outputs data for displaying the compatibility evaluation results on a map as the communication quality estimation results, and thus, it is possible to see visually the communication quality that can be attained in the cell.

Also, the traffic management server 143 subdivides the map into regions of a prescribed size, and outputs data for displaying on a map the communication quality estimation results calculated at each position in the subdivided regions, and thus, it is possible to visually see the communication quality that can be attained in the cell.

The traffic management server 143 transmits the estimated communication quality value, which was calculated, to the P-GW 133, and the P-GW 133 controls the forwarding of data transmitted and received by the application on the basis of the estimated communication quality value, which was calculated, and thus, it is possible to run the application according to the communication quality.

In the present embodiment, an example was described in which data was gathered for each cell (ECGI) of the eNodeB 111, but in order to reduce the amount of processing, data may be gathered and processed per eNodeB 111 (eNB ID).

### Second Embodiment

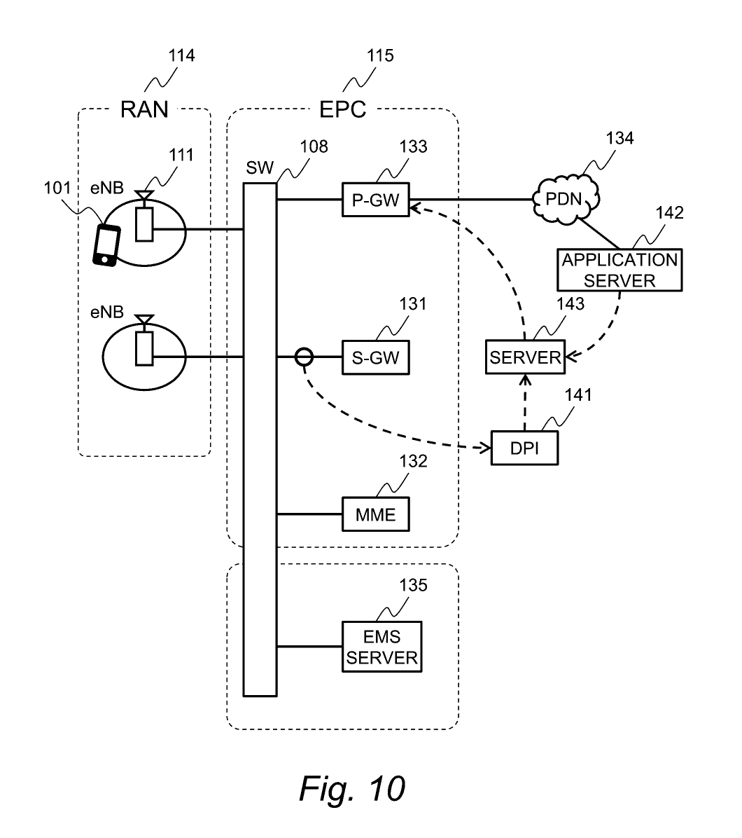

Below, the second embodiment of the present invention will be described with reference to FIGS. 10 to 19. In the second embodiment, the communication quality is estimated by obtaining information from the UE 101. In the second embodiment, only differences from the first embodiment mentioned previously will be described, and configurations and processes that are the same as those of the first embodiment are assigned the same reference characters and descriptions thereof are omitted.

FIG. 10 is a diagram illustrating a configuration of a wireless communication system according to the second embodiment.

The wireless communication system of the first embodiment has an eNodeB 111 that is a base station, S-GW 131 and P-GW 133 that are gateway apparatuses, an MME 132 that is a communication control apparatus, an EMS server 135, a deep packet inspectionapparatus 141 (DPI), an application server 142, and a traffic management server 143. The eNodeB 111 is connected to a UE 101, which is a user terminal.

The S-GW 131 has a traffic forwarding function for a user plane. The P-GW 133 has an interface with a PDN 134, which is a packet data network that provides a service to users. The MME 132 is an apparatus that manages the mobility of the UE 101, and transmits and receives control plane signaling. The S-GW 131, the P-GW 133, and the MME 132 are connected to each other and constitute a core network 115 (EPC).

The EMS server 135 is an element management system that manages nodes included in the wireless communication system. Specifically, the EMS server 135 gathers statistical information for each node (number of UEs 101 included in the eNodeB 111, CQI distribution, usage rate of physical resource blocks (PRB), etc.).

The deep packet inspection apparatus 141 obtains packets forwarded on the network, and obtains traffic transmitted and received between the eNodeB 111 and the S-GW 131, or signals transmitted and received between the S-GW 131 and the MME 132. The deep packet inspection apparatus 141 transmits the obtained traffic or signal information to the traffic management server 143. Specifically, the deep packet inspection apparatus 141 calculates the degree of congestion of the eNodeB 111 from the results of analyzing the packets, and transmits the degree of congestion to the traffic management server 143.

The application server 142 gathers logs from an information gathering program (not illustrated) operating in the UE 101 and transmits it to the traffic management server 143. The information gathered by the application server 142 includes, for example, the position information of the terminal, the wireless quality (SINR), and the communication quality (throughput, delay, packet loss).

The traffic management server 143 uses information obtained from the deep packet inspection apparatus 141 and the application server 142 to estimate communication quality.

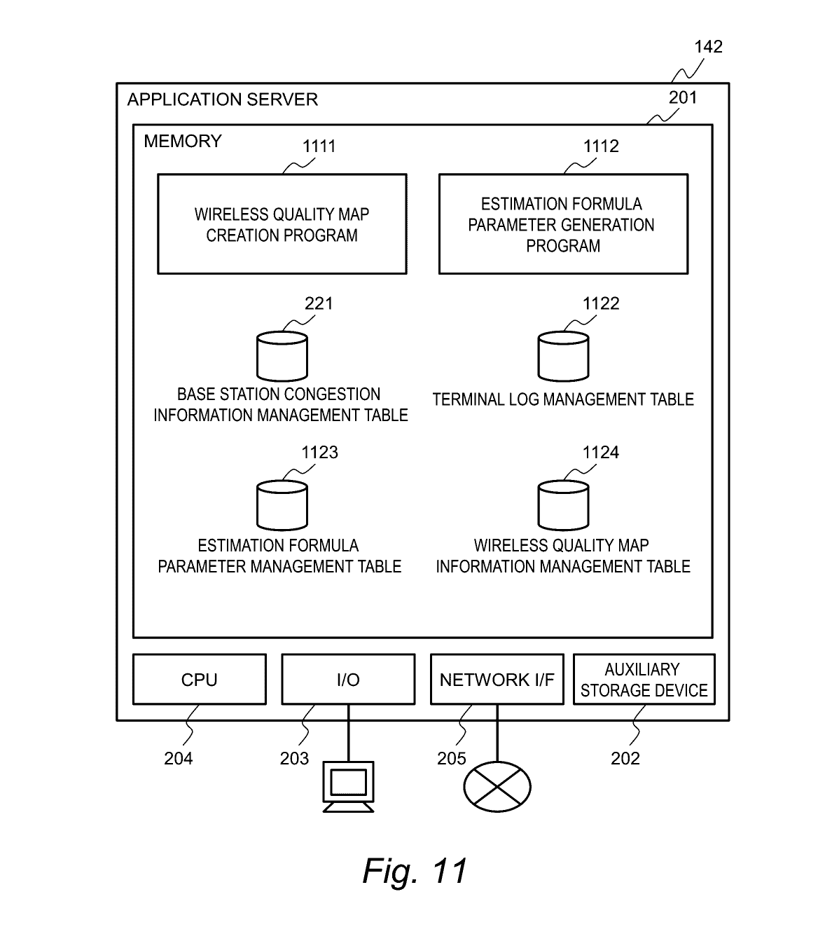

FIG. 11 is a diagram illustrating a configuration example of the application server 142 of the second embodiment.

The application server 142 is constituted of a general computer, and has a processor 204 (CPU), a memory 201, an auxiliary storage device 202, an input/output interface 203, and a network interface 205.

The input/output interface 203 is a user interface used in order for the user to input commands to the application server 142, and for displaying results of execution of a program to the user. An input/output device (such as a keyboard, mouse, display, or printer) is connected to the input/output interface 203. A user interface provided by the terminal connected through the network may be connected to the input/output interface 203.

The CPU 204 is a processor that executes programs stored in the memory 201. The memory 201 includes ROM, which is a non-volatile memory element, and RAM, which is a volatile memory element. The ROM includes fixed programs (such as the BIOS). The RAM is a high speed and volatile memory element such as DRAM (dynamic random access memory), and temporarily stores programs stored in the auxiliary storage device 202 and data used during execution of the programs.

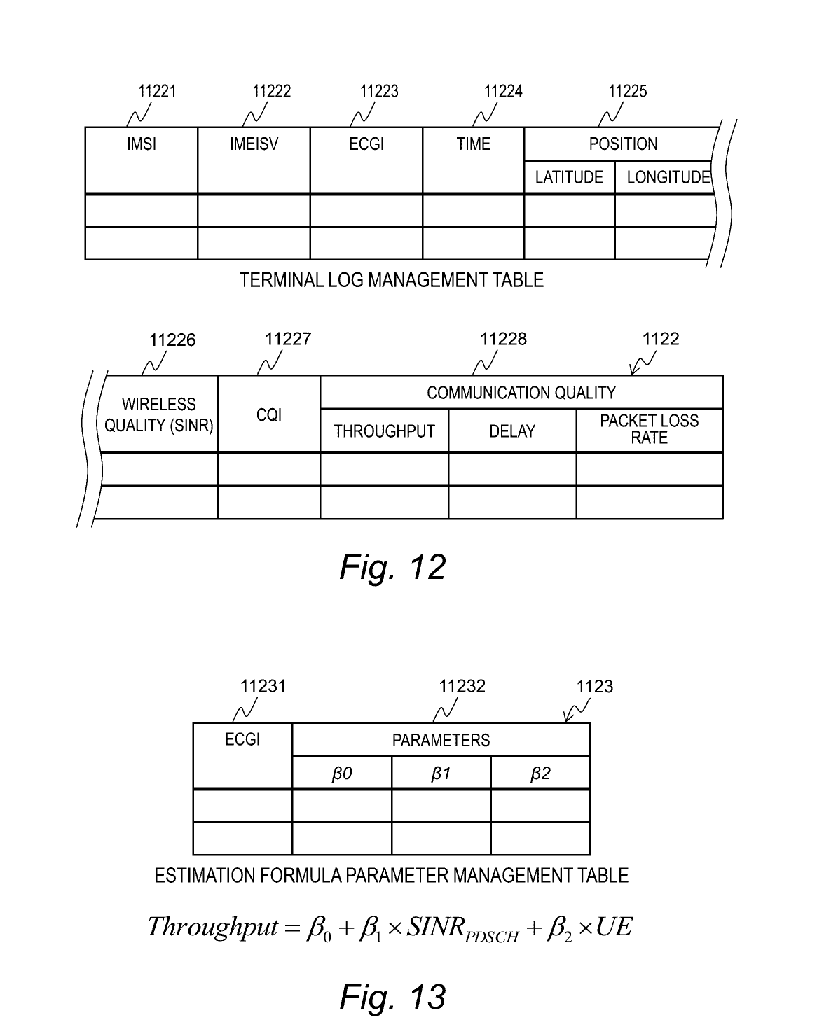

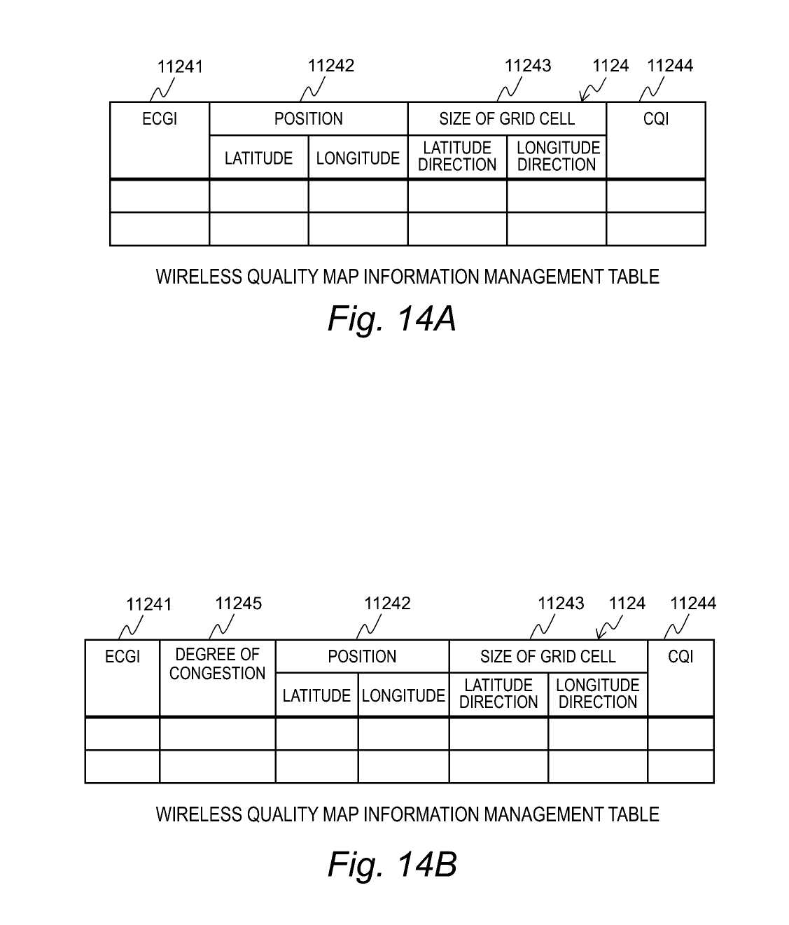

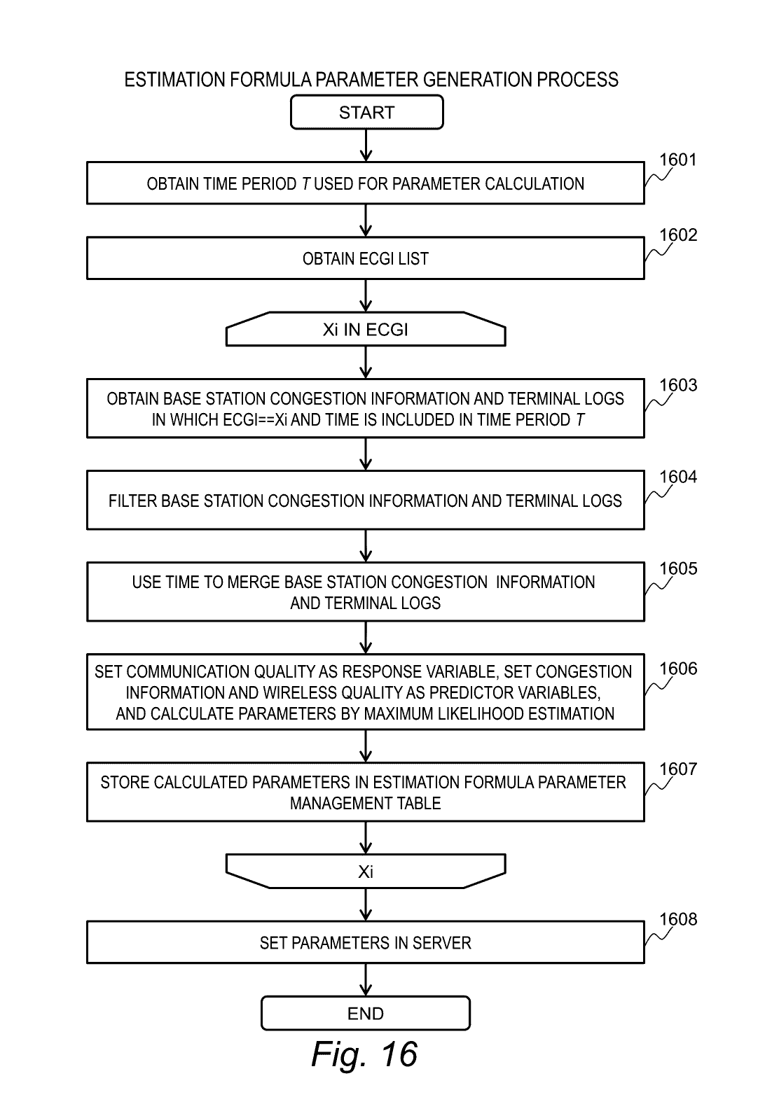

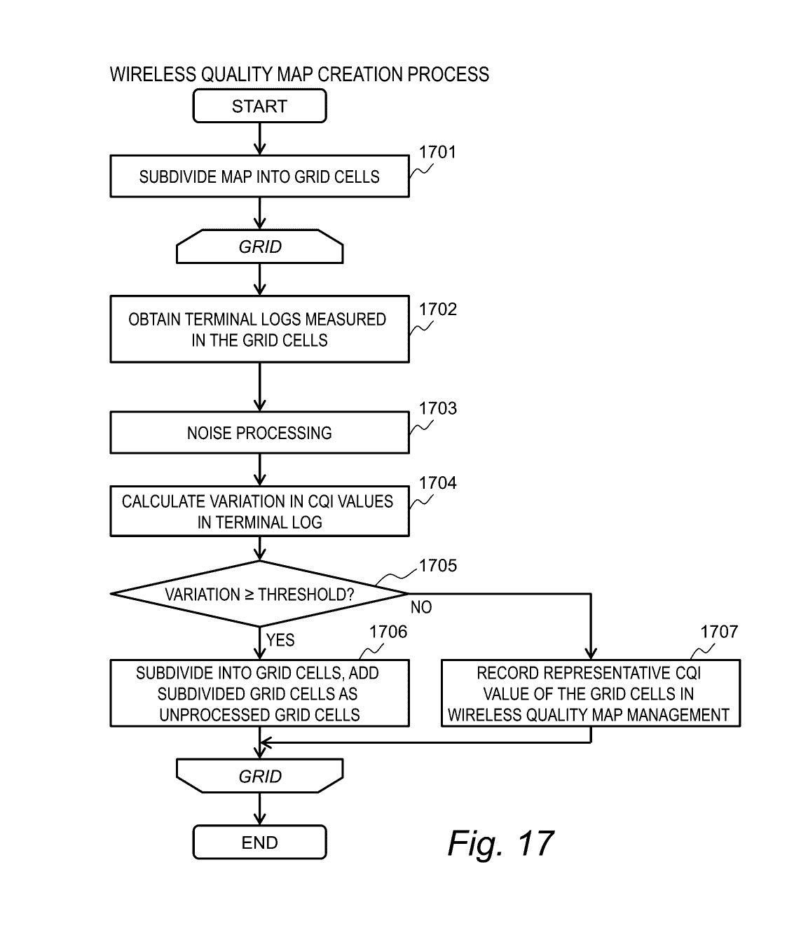

Specifically, the memory 201 stores a wireless quality map creation program 1111 and an estimation formula parameter generation program 1112. The wireless quality map creation program 1111 executes a wireless quality map creation process (see FIG. 17). The estimation formula parameter generation program 1112 executes an estimation formula parameter generation process (see FIG. 16). Also, the memory 201 stores a base station congestion information management table 221, a terminal log management table 1122 (see FIG. 12), an estimation formula parameter management table 1123 (see FIG. 13), and a wireless quality map information management table 1124 (see FIGS. 14A and 14B). The base station congestion information management table 221 stored in the memory 201 by the application server 142 may have the same configuration as the base station congestion information management table 221 (see FIGS. 4A and 4B) stored in the memory 201 by the traffic management server 143 of the first embodiment.

The auxiliary storage device 202 is a high capacity and non-volatile storage device such as a magnetic storage device (HDD) or flash memory (SSD), for example. Also, the auxiliary storage device 202 stores programs to be executed by the CPU 204 and data to be used while executing the programs. In other words, the programs are read from the auxiliary storage device 202, loaded into the memory 201, and executed by the CPU 204.

The network interface 205 is an interface device that controls communications with other devices (such as the traffic management server 143 and the PDN 134) through the network.

Programs executed by the CPU 204 are provided to the application server 142 through removable media (such as CD-ROMs and flash memory) or through a network, and are stored in a non-volatile storage device, which is a non-transitory storage medium. Thus, the application server 142 would have an interface for reading in data from removable media.

The application server 142 is a computer system constituted of one physical computer or a plurality of logical or physical computers, and the aforementioned programs may operate in individual threads on the same computer, or in a virtual computer created within a plurality of physical computer resources. Also, the application server 142 and any other device may be stored in one physical or logical computer.

Some or all of the functions of the function unit realized by the programs may alternatively be realized by hardware (such as a field-programmable gate array).

FIG. 12 is a diagram illustrating a configuration example of the terminal log management table 1122 of the second embodiment.

The terminal log management table 1122 stores logs gathered from the UE 101. Specifically, the terminal log management table 1122 includes an IMSI 11221 (international mobile subscriber identity) and an IMEISV 11222 (international mobile equipment identity software version) for uniquely identifying the UE 101, an ECGI 11223 for uniquely identifying a cell of the eNodeB 111 to which the UE 101 is connected, a time 11224 at which the information was calculated by the UE 101, a location 11225 (latitude, longitude) of the UE 101, an SINR 11226 (signal-to-interference plus noise power ratio) indicating the wireless quality of the UE 101, a CQI 11227 of the UE 101, and a communication quality 11228 of the UE 101. The communication quality 11228 includes throughput, delay, and packet loss, but may include only some of the indices shown, or may include other indices indicating communication quality (such as jitter). The position 11225 may be obtained from a GPS receiver provided in the UE 101, obtained by a transmission time delay difference between a plurality of eNodeBs or the intensity of the radio waves, or obtained from the SSID of a WiFi access point where reception is possible. The wireless quality 11226 and the CQI 11227 may be obtained from an API provided by the OS or directly obtained from an API provided by a wireless chipset. The communication quality 11228 may be obtained by obtaining the throughput measured using a throughput measurement site provided on the internet or the like, by obtaining the throughput and/or packet loss rate measured when downloading or uploading a certain amount of data after connecting to an existing server, by measuring delay or jitter by probing such as pinging an existing server, by measuring the RTT using a time stamp option of a TCP, or by combining these means. Also, in the case of creating a system in which the method for obtaining the communication quality 11228 differs among terminals, information indicating the measurement method may be obtained from the terminals, added to the terminal log management table 1122, and managed.

The CQI 11227 can be calculated according to the SINR 11226, and thus, need not necessarily be recorded in the terminal log management table 1122.

FIG. 13 is a diagram illustrating a configuration example of the estimation formula parameter management table 1123 of the second embodiment.

The estimation formula parameter management table 1123 stores parameters in a formula used to estimate throughput. Specifically, the estimation formula parameter management table 1123 includes an ECGI 11231 for uniquely identifying a cell in the eNodeB 111 to which the parameters are to be applied, and parameters 11232 (β0, β1, β2).

FIGS. 14A and 14B are diagrams illustrating configuration examples of the wireless quality map information management table 1124 of the second embodiment 2.

The wireless quality map information management table 1124 stores attributes in a grid plotted as a map, and one record represents the attributes of one grid cell. Specifically, the wireless quality map information management table 1124 illustrated in FIG. 14A includes the ECGI 11241 for uniquely identifying a cell of the eNodeB 111, the position 11242 (latitude, longitude) of the grid cells, the size 11243 (length in the latitude direction, width in the longitude direction) of the grid cells, and the CQI 11244.

Also, the wireless quality map information management table 1124 illustrated in FIG. 14B includes, in addition to the content of the wireless quality map information management table 1124 illustrated in FIG. 14A, a degree of congestion 11245. The degree of congestion 11245 is the degree of congestion at a certain time in a cell (eNodeB). As the degree of congestion increases, the effect of interference between adjacent cells increases, which worsens the CQI. Thus, by managing the CQI of the grid per degree of congestion, it is possible to calculate more accurately the CQI of the grid.

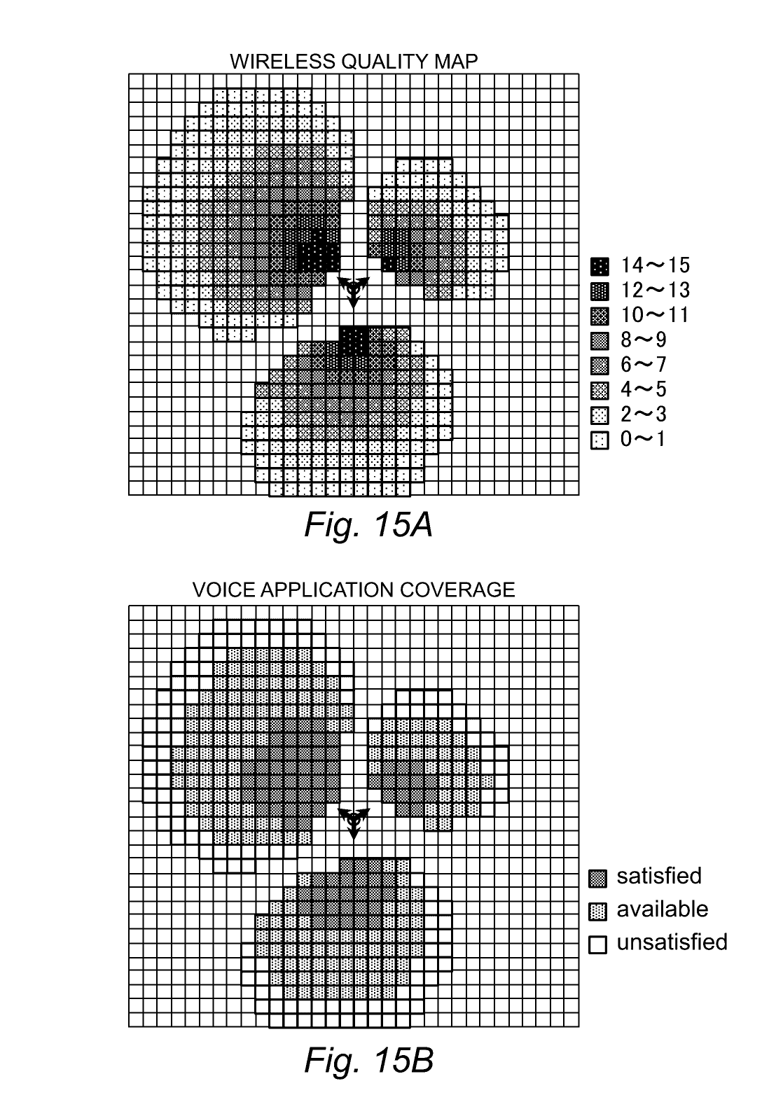

FIG. 15A is a diagram illustrating an example of a wireless quality map of the second embodiment, and FIG. 15B is a diagram illustrating an example of an application coverage map of the second embodiment.

The wireless quality map illustrated in FIG. 15A visually represents the CQI distribution in the cells in regions subdivided into grid cells of a prescribed size. According to this wireless quality map, it can be seen that a CQI allowing high speed transmission is allocated to the UE 101 in regions close to the eNodeB 111.

The application coverage map illustrated in FIG. 15B indicates the communication quality when using a voice application, for example. In the map, the communication quality corresponding to each channel quality indicator (CQI) is ranked into the following three availability levels: “satisfied”, indicating full quality being provided; “available”, indicating that a quality sufficient for use is being provided; and “unsatisfied”, indicating that satisfactory quality cannot be provided. The availability level is defined by the application-required quality management table 222, and indicates the user experience of the application, that is, to what degree the application is usable. In the present embodiment, the three availability levels (satisfied, available, and unsatisfied) are defined, but there may be any number of availability levels.

When comparing FIGS. 15A and 15B, of the 16 levels defined for the CQI, for example, a CQI of 10-14 is defined as “satisfied”, a CQI of 2-9 is defined as “available”, and a CQI of 0-1 is defined as “unsatisfied”.

Also, an estimated communication quality value may be displayed instead of the application availability level. The estimated communication quality value would be displayed in the case where a mouse cursor is placed on a displayed position in the grid, for example. Alternatively, the estimated communication quality value may be displayed in addition to the application availability level.

In this manner, by displaying the relation between the CQI and communication quality using an application coverage map, it is possible to represent the relationship between the application availability quality and the position.

FIG. 16 is a flow chart of an estimation formula parameter generation process of the second embodiment. The estimation formula parameter generation process is executed by the estimation formula parameter generation program 1112.

First, the estimation formula parameter generation program 1112 (CPU 204) obtains a period T needed to calculate the parameters (1601), and obtains an ECGI list (1602). The period T and the ECGI list can be obtained from information that is input by a user in an input/output device connected to the input/output interface 203.

The estimation formula parameter generation program 1112 uses a loop control parameter Xi for the ECGIs recorded in the obtained ECGI list and executes the process of steps 1603 to 1607 repeatedly.

In the loop, the estimation formula parameter generation program 1112 obtains base station congestion information and terminal logs where the ECGI is Xi and the time is included in the period T, from the base station congestion information management table 221 and the terminal log management table 1122, respectively (1603).

The estimation formula parameter generation program 1112 then filters the obtained base station congestion information and terminal logs (1604). The estimation formula parameters would be calculated using only data that is useful as statistical information from among the obtained base station congestion information and terminal logs, for example. Specifically, anomalous values resulting from the effect of noise, for example, are eliminated from the obtained base station congestion information and terminal logs. A prescribed percentage (such as 10%) may be removed from the top and bottom of the data.

The estimation formula parameter generation program 1112 uses the time to associate the base station congestion information with the terminal logs and then merges them (1605).

Then, the estimation formula parameter generation program 1112 sets the communication quality as the response variable, congestion information (number of connected UEs) and wireless quality as the predictor variables, and calculates the estimation formula parameters by maximum likelihood estimation (1606); and stores the calculated estimation formula parameters into the estimation formula parameter management table 1123 (1607).

After the estimation formula parameter generation program 1112 finishes calculating the estimation formula parameters for all ECGIs, it transmits the calculated estimation formula parameters to the traffic management server 143. The traffic management server 143 stores the received estimation formula parameters in the estimation formula parameter management table 1123 (1608).

FIG. 17 is a flow chart of a wireless quality map creation process of the second embodiment. The wireless quality map creation process is executed by the wireless quality map creation program 1111.

First the wireless quality map creation program 1111 subdivides the plotting area map into grid cells (1701).

Then, the wireless quality map creation program 1111 repeatedly executes the processes of steps 1702 to 1707 for each grid cell.

In the loop, the wireless quality map creation program 1111 obtains the terminal logs measured within the grid cells from the terminal log management table 1112 (1702). Specifically, it obtains the IMSI 11221, the IMEISV 11222, the ECGI 11223, the time 11224, the position 11225, and the SINR 11226.

Then, the wireless quality map creation program 1111 executes a noise process for the obtained terminal logs (1703). By removing anomalous values, for example, GPS measurement errors and SINR outliers are eliminated. Also, anomalous values resulting from the effect of noise, for example, are eliminated. A prescribed percentage (such as 10%) may be removed from the top and bottom of the data.

The variance in CQI values measured in one grid cell is calculated (1704), and the calculated variance is compared with a prescribed threshold (1705). In the case where, as a result, it is found that the calculated variance is greater than or equal to the prescribed threshold, then it is determined that the grid cell is too large, and the grid cell is further subdivided, and the grid cells generated by this subdivision are added as unprocessed grid cells (1706). On the other hand, in the case where the calculated variance is less than the prescribed threshold, then a representative value is determined from among the calculated CQI values in the grid cell, and recorded in the wireless quality map information management table 1124 (1707).

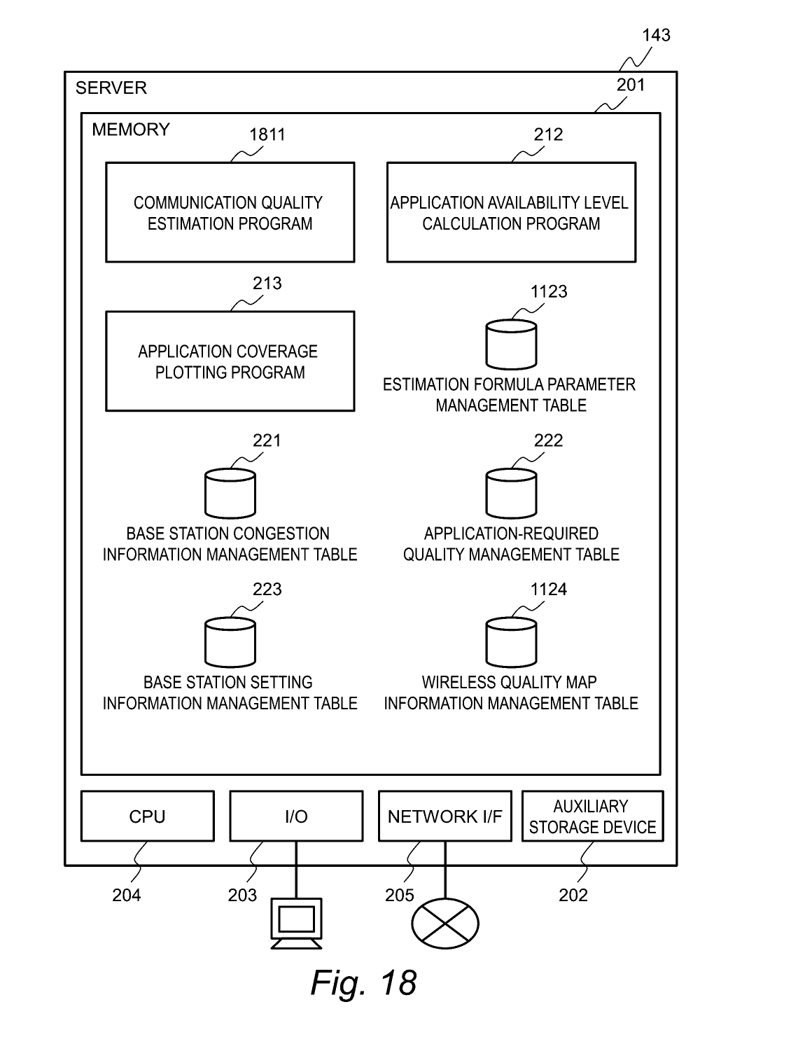

FIG. 18 is a diagram illustrating a configuration of a traffic management server 143 according to the second embodiment.

The traffic management server 143 is constituted of a general computer, and has a processor 204 (CPU), a memory 201, an auxiliary storage device 202, an input/output interface 203, and a network interface 205.

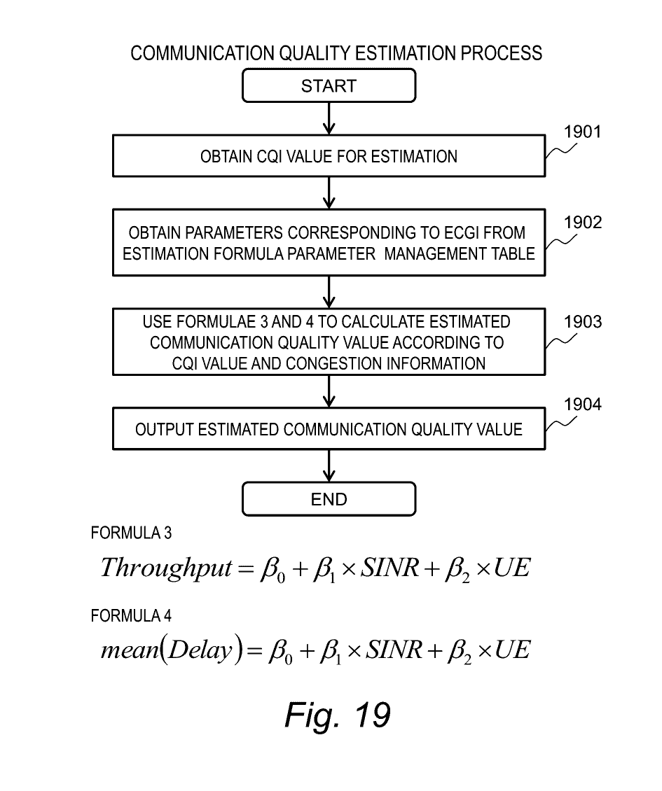

The memory 201 stores a communication quality estimation program 1811, an application availability level calculation program 212, and an application coverage plotting program 213. The communication quality estimation program 211 executes a communication quality estimation process (see FIG. 19). The application availability level calculation program 212 executes an application availability level calculation process (see FIG. 9). The application coverage plotting program 213 executes an application coverage plotting process (see FIG. 7).

Also, the memory 201 stores the base station congestion information management table 221 (see FIGS. 4A and 4B), the application-required quality management table 222 (see FIG. 5), the base station setting information management table 223 (see FIG. 6), the estimation formula parameter management table 1123, and the wireless quality map information management table 1124. The estimation formula parameter management table 1123 stored in the memory 201 by the traffic management server 143 may have the same configuration as the estimation formula parameter management table 1123 (see FIG. 13) stored in the memory 201 by the application server 142. Also, the wireless quality map information management table 1124 stored in the memory 201 by the traffic management server 143 may have the same configuration as the wireless quality map information management table 1124 (see FIGS. 14A and 14B) stored in the memory 201 by the application server 142.

Other previously mentioned configurations of the traffic management server 143 of the second embodiment are the same as those of the traffic management server 143 of the first embodiment (see FIG. 2), and thus, descriptions thereof are omitted.

FIG. 19 is a flow chart of a communication quality estimation process of the second embodiment. In the communication quality estimation process of the second embodiment, the communication quality is estimated using an estimation formula derived by multiple regression analysis. The communication quality estimation process is executed by the communication quality estimation program 1811.

First, the communication quality estimation program 1811 (CPU 204) obtains CQI values for which the communication quality is to be estimated (1901). The CQI values for which the communication quality is to be estimated may be obtained by obtaining from the terminal log management table 1122 CQI values in a cell provided by a certain eNodeB 111. The CQI value for which the communication is to be estimated quality may be obtained from information inputted by a user in an input/output device connected to the input/output interface 203.

The communication quality estimation program 1811 uses an ECGI corresponding to the obtained CQI value to obtain the parameters 11232 from the estimation formula parameter management table 1123 (1902). The communication quality estimation program 1811 uses formula 3 to calculate the estimated throughput value according to the SINR calculated from the CQI, and congestion information (number of connected UEs) obtained from the base station congestion information management table 221. Also, the estimated delay value is calculated by formula 4 (1903).

Throughput=β₀+β₁×SINR+β₂×UE Formula 3

mean(Delay)=β₀+β₁×SINR+β₂×UE Formula 4

Then, the communication quality estimation program 1811 outputs the estimated communication quality (throughput, delay), and stores it in the memory 201 (1904).

The wireless quality map creation process has been described above for a case in which a map is subdivided into grid cells and displayed, but a wireless quality map that is subdivided into objects on the map (spatial subdivisions such as roads and rooms in buildings, for example) may be created.

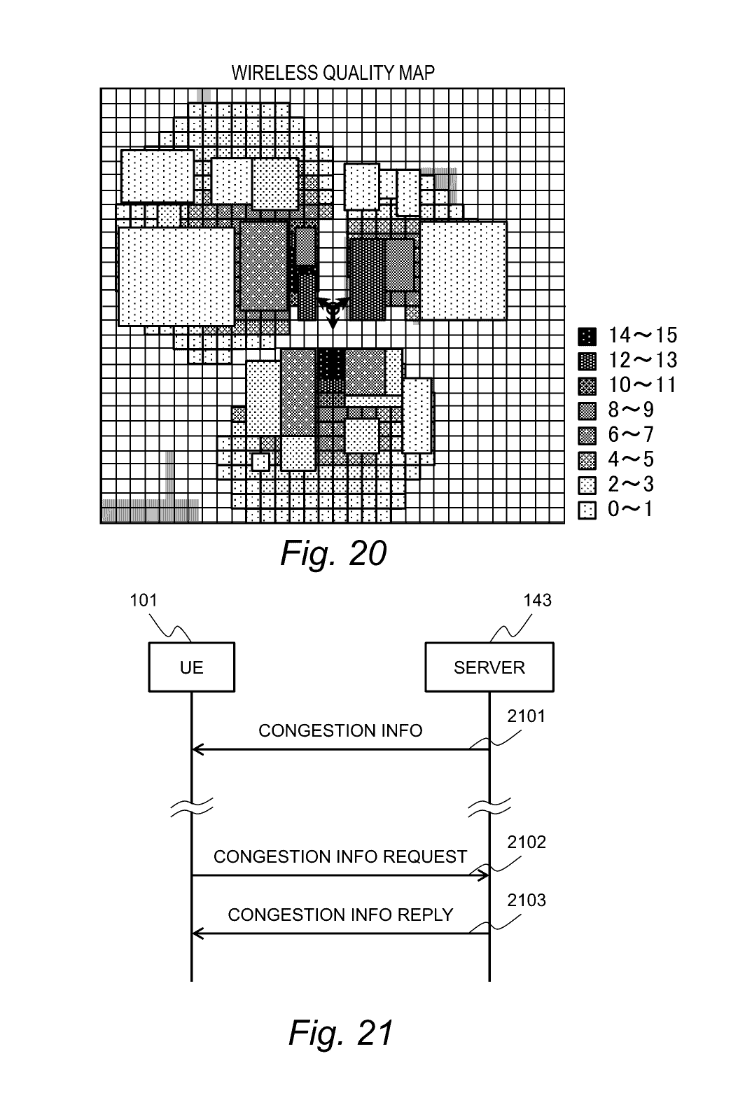

FIG. 20 is a diagram illustrating another example of the wireless quality map of the second embodiment. The wireless quality map illustrated in FIG. 20 visually represents the CQI distribution in object regions on the map, in addition to CQIs in grid cells that are subdivisions of the wireless quality map such as previously mentioned (FIG. 15A). The objects are spatial subdivisions in which CQIs showing similar trends are attained, and examples thereof include roads and rooms in buildings.

In the second embodiment, one representative CQI value is set per object. Similar to the previously mentioned steps 1704 to 1706, a configuration may be adopted in which the variance in measured CQI values is calculated for one object, where in the case where the calculated variance in CQI values is greater than or equal to a threshold, then it is determined that the range of the object is inappropriate and the object is further subdivided.

In this manner, by representing CQIs of objects on a communication quality map, it is possible to display CQIs in a space with the same characteristics. Furthermore, by associating the CQI with the availability level for the application, it is possible to represent the relationship between the application availability quality and the position.

As described above, in the second embodiment of the present invention, the traffic management server 143 calculates estimated values for the communication quality (throughput, delay, etc.) of the UE 101 from a polynomial that includes as variables the degree of congestion (number of connected UEs) in the eNodeB 111 cell and the wireless quality (CQI) of the UE 101, and thus, the communication quality of the UE 101 can be accurately estimated.

Also, the traffic management server 143 analyzes the relationship between the wireless quality and communication quality gathered from the wireless terminal, and the congestion information gathered from the wireless base station, and calculates a coefficient included in a formula used for estimating the communication quality, and thus, it is possible to calculate the estimation formula using the deep packet inspection apparatus 141 and information obtained from the UE 101.

Also, the traffic management server 143 subdivides the map into spatial regions in which CQI values that exhibit the same trend can be attained, and outputs data for displaying on a map the communication quality estimation results calculated at each position in the subdivided regions, and thus, it is possible to visually see the communication quality that can be attained in the cell.

The traffic management server 143 transmits the estimated communication quality value, which was calculated, to the P-GW 133, and the P-GW 133 controls the forwarding of data transmitted and received by the application on the basis of the estimated communication quality value, which was calculated, and thus, it is possible to run the application according to the communication quality.

In the present embodiment, an example was described in which data was gathered for each cell (ECGI) of the eNodeB 111, but in order to reduce the amount of processing, data may be gathered and processed per eNodeB 111 (eNB ID).

### Third Embodiment

Below, a third embodiment of the present invention will be described with reference to FIGS. 21 to 24. In the third embodiment, the UE 101 estimates communication quality.

FIG. 21 is a sequence diagram of a message exchange between a UE 101 and a traffic management server 143 according to the third embodiment.

In the third embodiment, the UE 101 estimates communication quality. However, the UE 101 does not store congestion information (number of connected UEs) in the cell of the eNodeB to which the UE 101 belongs. Thus, the traffic management server 143 transmits the congestion information to the UE 101. Two forms of transmission of congestion information from the traffic management server 143 to the UE 101 are possible. One is for the traffic management server 143 to transmit congestion information to the UE 101 at a prescribed timing (2101). Specifically, the congestion information would be broadcasted or multicasted at a prescribed timing interval. Another is for the traffic management server 143 to transmit congestion information to the UE 101 according to the request 2102 from the UE 101 (2103).

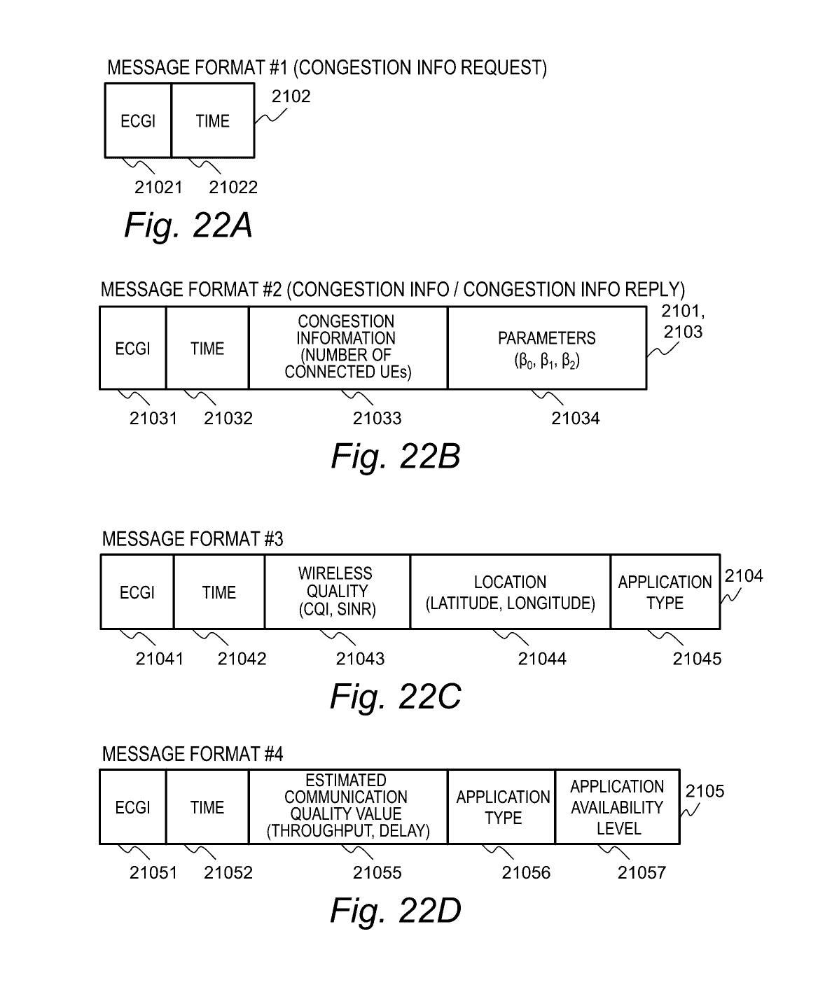

FIGS. 22A to 22D are diagrams illustrating the formats of messages transmitted and received between the UE 101 and the traffic management server 143 according to the third embodiment.

As illustrated in FIG. 22A, a congestion information request message 2102 that the UE 101 transmits to the traffic management server 143 includes an ECGI 21021 of the eNodeB 111 for which the requested congestion information was obtained, and a time 21022 at which the requested congestion information was obtained. The time 21022 may be in the future. As a result of the traffic management server 143 estimating congestion information in the future, it is possible to estimate future communication quality.

In the case where the traffic management server 143 receives the congestion information request message 2102, it transmits a congestion information reply message 2103 illustrated in FIG. 22B to the UE 101. The congestion information reply message 2103 includes the ECGI 21031 for which the congestion information was obtained, a time 21032 at which the congestion information was obtained, and congestion information 21033 (such as the number of connected UEs). In the case where the estimation method of the second embodiment is to be used, the congestion information reply message 2103 includes estimation formula parameters 21034 (β0, β1, β2). In the case where the UE 101 retains the estimation formula parameters (β0, β1, β2), then the traffic management server 143 need not necessarily transmit the estimation formula parameters 21034 (β0, β1, β2).

Also, the congestion information request message 2101 that the traffic management server 143 transmits all at once to the UE 101 may have the same format as the congestion information reply message 2103 illustrated in FIG. 22B.

In a modification example of the third embodiment, the UE 101 may obtain the communication quality estimated by the traffic management server 143 or the application availability level calculated by the traffic management server 143, instead of the UE 101 estimating the communication quality.

In such a case, as illustrated in FIG. 22C, an estimated communication quality value request message 2104 that the UE 101 transmits to the traffic management server 143 includes an ECGI 21041 for which the required congestion information was obtained, a time 21042 at which the required congestion information was obtained, a wireless quality 21043 (such as CQI, SINR), a position 21044 (latitude, longitude) of the UE 101, and an application type 21045. The time 21042 may be in the future. The position 21044 may be any position. As a result of the traffic management server 143 estimating congestion information in the future, it is possible to estimate future communication quality at any location. Alternatively, the application availability level may be obtained by including one or more application types to be used in the application type 21045. Also, a configuration may be adopted in which a plurality of groups of the time 21042, wireless quality 21043, position 21044 of the UE 101, and application type are included, with it being possible to obtain simultaneously the communication quality or application availability levels at a plurality of positions or at a plurality of times.

Additionally, as illustrated in FIG. 22D, a congestion information reply message 2105 that the traffic management server 143 transmits includes an ECGI 21051 for which the congestion information was obtained, a time 21052 at which the congestion information was obtained, and an estimated communication quality value 21055 (such as throughput and delay). Alternatively, one or more of the application type 21056 and the application availability level 21057 may be included.

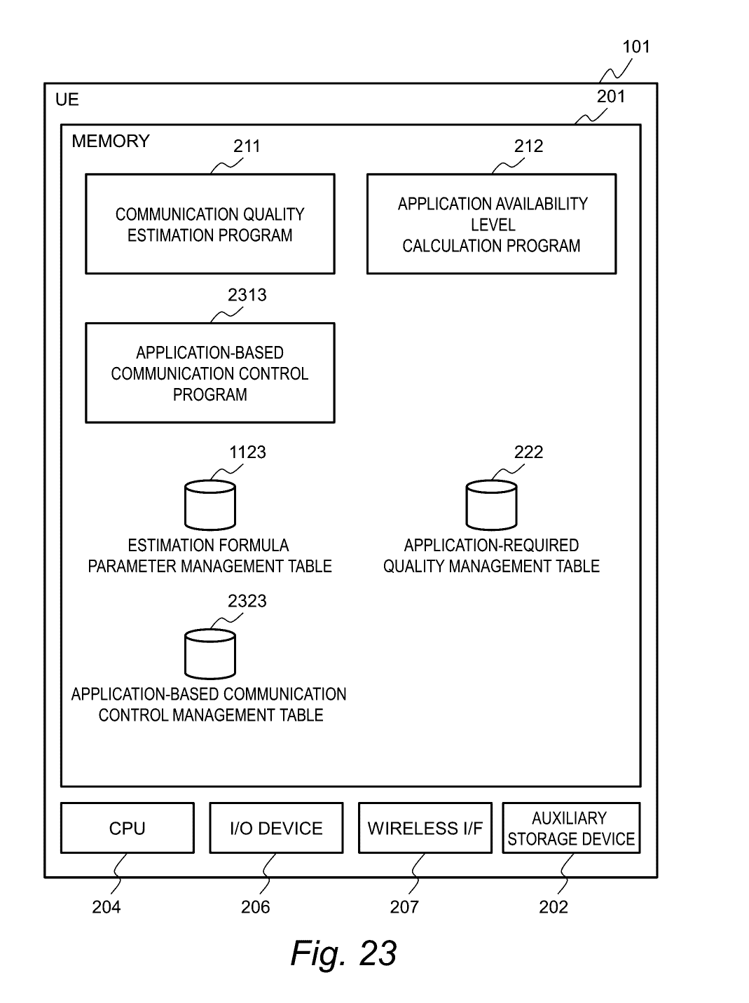

FIG. 23 is a diagram illustrating a configuration of the UE 101 according to the third embodiment.

The UE 101 is a general communication device (such as a smartphone, a tablet computer, or a mobile phone, for example), and has a processor 204 (CPU), a memory 201, an auxiliary storage device 202, an I/O device 206, and a wireless interface 207.

The CPU 204 is a processor that executes programs stored in the memory 201. The memory 201 includes ROM, which is a non-volatile memory element, and RAM, which is a volatile memory element. The ROM includes fixed programs (such as the BIOS). The RAM is a high speed and volatile memory element such as DRAM (dynamic random access memory), and temporarily stores programs stored in the auxiliary storage device 202 and data used during execution of the programs.

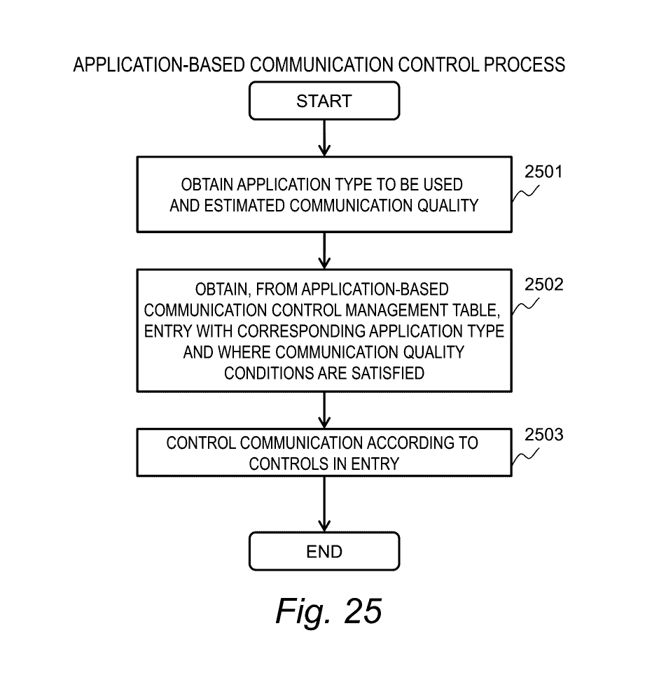

Specifically, the memory 201 stores a communication quality estimation program 211, an application availability level calculation program 212, and an application-based communication control program 2313. The communication quality estimation program 211 executes a communication quality estimation process (see FIG. 8) using the congestion information obtained from the traffic management server 143 to estimate communication quality. The application availability level calculation program 212 executes an application availability level calculation process (see FIG. 9). The application-based communication control program 2313 executes an application-based communication control process (see FIG. 25). The memory 201 may store the communication quality estimation program 1811 of the second embodiment instead of the communication quality estimation program 211. The communication quality estimation program 1811 executes a communication quality estimation process (see FIG. 19).

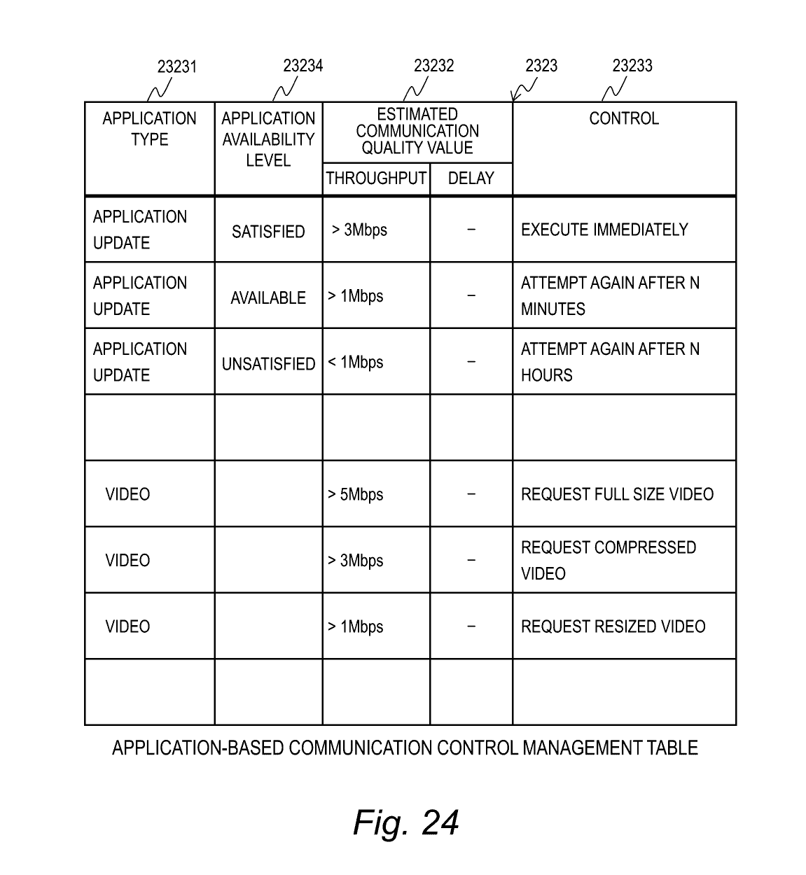

Also, the memory 201 stores the application-required quality management table 222 (see FIG. 5), the estimation formula parameter management table 1123 (see FIG. 13), an application-based communication control management table 2323 (see FIG. 24), and the wireless quality map information management table 1124.

The auxiliary storage device 202 is a high capacity and non-volatile storage device such as flash memory (SSD) or a magnetic storage device (HDD), for example. Also, the auxiliary storage device 202 stores programs to be executed by the CPU 204 and data to be used while executing the programs. In other words, the programs are read from the auxiliary storage device 202, loaded into the memory 201, and executed by the CPU 204.

The I/O interface 206 is a user interface used in order for the user to input commands to the UE 101, and to display results of execution of a program to the user, and is a touch panel, a display, or the like. The wireless interface 207 is a wireless communication device used to connect the UE 101 to the eNodeB 111.

Programs executed by the CPU 204 are provided to the UE 101 through a network or removable media (such as flash memory), and are stored in a non-volatile storage device, which is a non-transitory storage medium. Thus, the UE 101 would have an interface (such as a USB interface) for reading in data from removable media.

Some or all of the functions of the function unit realized by the programs may alternatively be realized by hardware (such as a field-programmable gate array).

FIG. 24 is a diagram illustrating a configuration example of the application-based communication control management table 2323 according to the third embodiment.

The application-based communication control management table 2323 includes an application type 24231, an application availability level 23234, an estimated communication quality value 23232 (throughput, delay), and a control value 23233 that indicates control content for the UE 101 under each condition.

FIG. 25 is a flow chart of an application-based communication control process according to the third embodiment. The application-based communication control process is executed by the application-based communication control program 2313.

First, the application-based communication control program 2313 (CPU 204) obtains the type of application that the user uses, and the application availability level or estimated communication quality value (2501). The estimated communication quality value may be a value calculated by the communication quality estimation program 211 or 1811 in the UE 101 or on a TMS server.

The application-based communication control program 2313 uses the application type and the application availability level or the communication quality (throughput, delay) to search the application-based communication control management table 2423, and obtains from the application-based communication control management table 2423 entries that match the application type and that satisfy conditions for the application availability level or communication quality (2502). In the case where there are a plurality of entries satisfying the search conditions, then the topmost entry would be selected (such as the entry with the most stringent conditions).

The application-based communication control program 2313 controls communication according to the control defined in the entry (2503). The availability of communication for an application in use on the UE 101, and the communication method (network, video compression rate, image size, video buffering size) are selected on the basis of the application and the estimated communication quality value (or application availability level) that has been calculated, for example.

In this manner, the application-based communication control management table 2323 (FIG. 24) indicates that in the case where a high throughput is estimated, then an application update is immediately executed, and in the case where a low throughput is estimated, then the application update should be delayed for a prescribed period of time. The delay time for the application update would be changed according to throughput. In the case of video applications, the application-based communication control management table 2323 defines that in the case where a high throughput is estimated, then the full size version of the video is requested; in the case where a low throughput is estimated, then a compressed version of the video is requested; and in the case where an even lower throughput is estimated, a resized video is requested.

In the application-based communication control process, the operation of the application is controlled according to the communication quality, and the estimated communication quality value and application availability level may be displayed in the UE 101. By the user knowing the application availability level, it is possible for the user to know whether a sufficient communication quality for the running of the application can be ensured. In the case where it is estimated that a prescribed communication quality cannot be attained, then the user may be recommended to view a low resolution video, for example.

Also, the application coverage map may be displayed in the UE 101. By the user seeing the application coverage map, it is possible for the user to know the place and time at which a sufficient communication quality for the running of the application can be ensured.

As described above, in the third embodiment of the present invention, the UE 101 calculates estimated values for the communication quality (throughput, delay, etc.) of the UE 101 from the degree of congestion (number of connected UEs) in the eNodeB 111, which is gathered by the traffic management server 143, and the wireless quality (CQI) of the UEs 101, and thus, the communication quality can be accurately estimated, and it can be seen whether the communication quality is suitable for the use of the application.

Also, the UE 101 estimates the communication quality using a formula including as variables the capability of the eNodeB 111, the wireless quality distribution of UEs 101 in the cell provided by the eNodeB 111, and a value determined according to the type of scheduling for allocating the wireless resources in the eNodeB 111, and thus, it is possible to accurately estimate the communication quality using only information that can be obtained from the EMS server 135.

Additionally, the UE 101 calculates estimated values for the communication quality (throughput, delay, etc.) of the UE 101 from a polynomial that includes as variables the degree of congestion (number of connected UEs) in the eNodeB 111 and the wireless quality (CQI) of the UE 101, and thus, the communication quality can be accurately estimated.

The UE 101 controls the operation of applications running in the UE 101 on the basis of the estimated communication quality value that has been calculated, and thus, it is possible to run the application according to the communication quality.

The traffic management server 143 transmits the estimated communication quality value that has been calculated to the UE 101, in order to control the operation of the application in use on the UE 101, and the UE 101 controls the operation of the application on the basis of the estimated communication quality value that has been calculated, and thus, it is possible to run the application according to the communication quality.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. A communication management apparatus that manages traffic of a communication system, comprising:
a storage unit which stores a program; and
a processor which executes the program stored in the storage unit,
wherein the communication system includes a wireless base station that communicates with a wireless terminal, and a gateway apparatus connected to the wireless base station, and
wherein the communication management apparatus is configured to:
obtain a degree of congestion of the wireless base station;
obtain a wireless quality of the wireless terminal, between the wireless base station and the wireless terminal; and
calculate an estimated communication quality value of the wireless terminal between the gateway apparatus and the wireless terminal, according to the degree of congestion of the wireless base station and the obtained wireless quality of the wireless terminal.

2. The communication management apparatus according to claim 1, further configured to estimate the communication quality using a formula including, as variables, a capability of the wireless base station, a wireless quality distribution for the wireless terminal in a cell provided by the wireless base station, and a value determined according to a scheduler type for allocating wireless resources in the wireless base station.

3. The communication management apparatus according to claim 1, further configured to estimate the communication quality using a polynomial including, as variables, the degree of congestion of the wireless base station and the wireless quality of the wireless terminal, and a coefficient calculated by analyzing a relationship between the wireless quality and the communication quality gathered from the wireless terminal, and congestion information gathered from the wireless base station.

4. The communication management apparatus according to claim 1, further configured to output data for displaying results of estimating the communication quality on a map on which a position of the wireless terminal in the cell and the wireless quality are displayed in association with each other.

5. The communication management apparatus according to claim 4, further configured to:
hold a required value for a communication quality necessary for an application in use on the wireless terminal,
compare the estimated communication quality value that has been calculated with the held required value for the communication quality, and evaluate an availability of the application in multiple stages, and
output data for displaying evaluation results for the availability on a map as results of estimating the communication quality.

6. The communication management apparatus according to claim 4, further configured to:
subdivide the map into regions of a prescribed size; and
output data for displaying on the map results of estimating the communication quality calculated at each position in the subdivided regions.

7. The communication management apparatus according to claim 1, further configured to transmit the estimated communication quality value that has been calculated to the wireless terminal in order to control an operation of an application in use on the wireless terminal.

8. The communication management apparatus according to claim 1, further configured to transmit the estimated communication quality value that has been calculated in order to cause the gateway apparatus to control forwarding of data transmitted and received by an application in use on the wireless terminal.

9. A wireless terminal that communicates with a wireless base station, comprising:
a storage unit which stores a program; and
a processor which executes the program stored in the storage unit,
wherein the wireless terminal is configured to connect to a communication management apparatus that manages traffic in a communication system that includes the wireless base station and a gateway apparatus connected to the wireless base station,
wherein the wireless terminal is configured to:
obtain a degree of congestion of the wireless base station gathered by the communication management apparatus,
obtain a wireless quality of the wireless terminal, between the wireless base station and the wireless terminal, and
calculate an estimated communication quality value of the wireless terminal between the gateway apparatus and the wireless terminal, according to the degree of congestion of the wireless base station and the obtained wireless quality of the wireless terminal.

10. The wireless terminal according to claim 9, further configured to estimate the communication quality using a formula including, as variables, a capability of the wireless base station, a wireless quality distribution for the wireless terminal in a cell provided by the wireless base station, and a value determined according to a scheduler type for allocating wireless resources in the wireless base station.

11. The wireless terminal according to claim 9, further configured to estimate the communication quality using a polynomial including, as variables, the degree of congestion of the wireless base station and the wireless quality of the wireless terminal, and a coefficient calculated by analyzing a relationship between the wireless quality and the communication quality gathered from the wireless terminal, and congestion information gathered from the wireless base station.

12. The wireless terminal according to claim 9, further configured to control an application running on the wireless terminal on the basis of the estimated communication quality value that has been calculated.

13. A non-transitory machine-readable storage medium, containing at least one sequence of instructions for managing traffic of a communication system,
wherein the communication system includes a communication management apparatus that manages traffic of a communication system, a wireless base station that communicates with a wireless terminal, and a gateway apparatus connected to the wireless base station,
wherein the communication management apparatus includes a processor that executes the instructions, and a memory that stores the instructions, and
the instructions that, when executed, causes the communication management apparatus to:
obtain a degree of congestion of the wireless base station;
obtain a wireless quality of the wireless terminal, between the wireless base station and the wireless terminal, and
calculate an estimated communication quality value of the wireless terminal between the gateway apparatus and the wireless terminal, according to the obtained degree of congestion of the wireless base station and the obtained wireless quality of the wireless terminal.

14. The non-transitory machine-readable storage medium according to claim 13,
wherein, in the step of calculating the estimated communication quality value of the wireless terminal, the instructions causes the communication management apparatus to estimate the communication quality using a formula including, as variables, a capability of the wireless base station, a wireless quality distribution for the wireless terminal in a cell provided by the wireless base station, and a scheduler type for allocating wireless resources in the wireless base station.

15. The non-transitory machine-readable storage medium according to claim 13,
wherein, in the step of calculating the estimated communication quality value of the wireless terminal, the instructions causes the communication management apparatus to estimate the communication quality using a polynomial including, as variables, the degree of congestion of the wireless base station and the wireless quality of the wireless terminal, and a coefficient calculated by analyzing a relationship between the wireless quality and the communication quality gathered from the wireless terminal, and congestion information gathered from the wireless base station.
